(19) United States
(12) Patent Application Publication
(10) Pub. No.: US 2015/0277780 A1
(43) Pub. Date: Oct. 1, 2015

(54) SERVER APPARATUS, RECORDING MEDIUM STORING INFORMATION STORAGE PROGRAM, AND INFORMATION STORING METHOD

(71) Applicant: FUJITSU LIMITED, Kawasaki-shi (JP)

(72) Inventor: Tatsuo KUMANO, Kawasaki (JP)

(21) Appl. No.: 14/637,714

(22) Filed: Mar. 4, 2015

(30) Foreign Application Priority Data
Mar. 28, 2014 (JP) 2014-069482

(51) Int. Cl. G06F 3/06

(52) U.S. Cl. CPC G06F 3/0611; G06F 3/0646; G06F 3/0689

(57) ABSTRACT

A server apparatus includes a storage unit configured to store speed information about a speed of a sequential access to a storage area for each specified storage area in each of a plurality of storage devices and a control unit configured to perform a process including selecting at least two storage devices among the plurality of storage devices in response to an access request made to any of the plurality of storage devices, identifying storage areas having a difference in the speed of the sequential access that is equal to or slower than a specified threshold value from among the storage areas of the selected storage devices by using the speed information and storing data in each of the identified storage areas.

### CROSS-REFERENCE TO RELATED APPLICATION

This application is based upon and claims the benefit of priority of the prior Japanese Patent Application No. 2014-069482, filed on Mar. 28, 2014, the entire contents of which are incorporated herein by reference.

### FIELD

The embodiments discussed herein are related to storing of information.

### BACKGROUND

One of auxiliary storage devices in which data is recorded and from which data is read is a Hard Disk Drive (HDD). One of characteristics of accesses of an HDD is a characteristic such that a performance difference in a sequential access occurs between inner and outer circumferential portions. A sequential access is a method that sequentially searches and accesses an HDD from the start of the HDD.

An access performance of an HDD reaches the highest level in the outer circumferential portion, and drops to a lower level toward the inner circumferential portion. Such an HDD characteristic is caused because data is recorded at almost the same line density in cylinders when the HDD is divided into the concentric cylinders. Each of the cylinders is divided into units called sectors. Moreover, sectors of the HDD are managed by using serial-numbered addresses called logical block addresses (LBA).

FIG. 1 illustrates an example of performance differences in areas to be accessed of an HDD. In FIG. 1, logical block addresses are assigned sequentially from an outer circumferential sector. At this time, the performance increases as an access is performed to an area having a smaller logical block address, and decreases as an access is performed to an area indicated with a larger logical block address. Note that there is almost no difference in a performance of a random access between inner and outer circumferential portions of the HDD.

In the meantime, techniques related to a data access include the following first to third techniques.

The first technique is related to an image forming device provided with an auxiliary storage device that has different write speeds in each area and within an area. The image forming device according to the first technique includes means for setting a write speed of each area of the auxiliary strange device on the basis of an actually measured value of the auxiliary storage device when being evaluated, and data transfer speed setting means for setting a transfer speed needed for each piece of data stored in the auxiliary storage device. The image forming device according to the first technique further includes data storage area allocation means for allocating, as a data storage area, an area set to a write speed equal to or faster than the set transfer speed.

A second technique is related to a disk device write control method executed in a device that records data by using two insertable and removable disk devices as media for recording data. With the write control method according to the second technique, capacities and write performances of the two connected disk devices are detected, and whether both a difference between the capacities and that between the write performances of the two disk devices are respectively within a predetermined range. Moreover, the write control method according to the second technique, one of the disk devices writes data from an outer circumference to an inner circumference when both the difference between the capacities and that between the write performances of the two disk devices are within the predetermined range. Additionally, with the write control method according to the second technique, the other disk device writes data from the inner circumference to the outer circumference, and divides and writes the data in accordance with a ratio between the detected write performances.

A third technique is related to a disk processing device provided with two or more disks having outer circumferential tracks and inner circumferential tracks in which the number of sectors is smaller than that of the outer circumferential tracks. The device according to the third technique writes the same data to at least part of an outer circumferential track of a first disk and at least part of an inner circumferential track of a second disk when the same data is written to the first disk among two or more disks and the second disk different from the first disk.

Patent Document 1: Japanese Laid-open Patent Publication No. 2010-124142

Patent Document 2: Japanese Laid-open Patent Publication No. 2008-90414

Patent Document 3: Japanese Laid-open Patent Publication No. HEI10-320130

### SUMMARY

A server apparatus according to an aspect of the embodiments includes a storage unit configured to store speed information about a speed of a sequential access to a storage area for each specified storage area in each of a plurality of storage devices; and a control unit configured to perform a process including: selecting at least two storage devices among the plurality of storage devices in response to an access request made to any of the plurality of storage devices; identifying storage areas having a difference in the speed of the sequential access that is equal to or slower than a specified threshold value from among the storage areas of the selected storage devices by using the speed information; and storing data in each of the identified storage areas.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF EXPLANATION OF DRAWINGS

FIG. 1 illustrates an example of performance differences in areas to be accessed of an HDD.

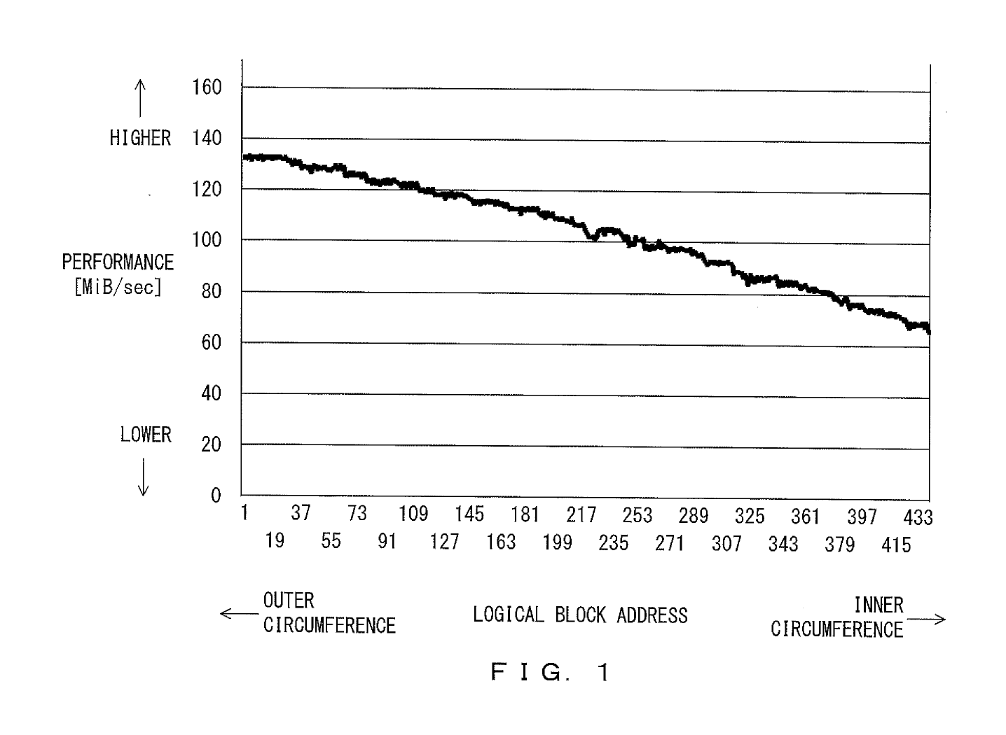

FIG. 2 is a functional block diagram illustrating a configuration of an implementation example of a server apparatus.

FIG. 3 illustrates an example of a configuration of a storage system according to an embodiment.

FIG. 4 is an explanatory diagram of operations performed when a write request is transmitted from a client to a server.

FIG. 5 illustrates an example of a configuration of a server according to an embodiment.

FIG. 6 illustrates an example of performance information according to the first embodiment.

FIG. 7 illustrates an example of a structure of performance management information according to the first embodiment.

FIG. 8 illustrates an example of a structure of empty area information according to the first embodiment.

FIG. 9 illustrates an example of a structure of empty area management information according to the first embodiment.

FIG. 10 is a flowchart illustrating details of a process for measuring a read performance and a write performance, according to the first embodiment.

FIG. 11 is a flowchart illustrating details of a write process for a server that decides a storage position, according to the embodiment.

FIG. 12 is a flowchart illustrating details of a process of a server that receives a write instruction from the server that decides a storage position, and executes a write process, according to the embodiment.

FIG. 13 is a flowchart illustrating details of a storage position decision process according to the embodiment.

FIG. 14 illustrates an example of a hardware configuration of the server according to the embodiment.

FIG. 15 illustrates an example of a configuration of a server according to the second embodiment.

FIG. 16 illustrates an example of performance information according to the second embodiment.

FIG. 17 illustrates an example of a structure of performance management information according to the second embodiment.

FIG. 18 illustrates an example of a structure of empty area information according to the second embodiment.

FIG. 19 illustrates an example of a structure of empty area management information according to the second embodiment.

FIG. 20 is a flowchart illustrating details of a process for measuring a write performance and a read performance, according to the second embodiment.

### DESCRIPTION OF EMBODIMENTS

When data is made redundant by using a plurality of disks, a difference occurs in performances of a sequential access to the redundant data in the disks if positions at which the data is recorded differ in the redundant disks. In this case, the sequential access performance of the entire system is limited to a lower performance. Accordingly, if a difference occurs in the sequential access performances of disks in a redundant system, the entire system becomes inefficient.

However, none of the above described first to third techniques take into account a difference in the sequential access performances of redundant disks when data is made redundant and recorded onto the plurality of disks.

Accordingly, one aspect of the embodiments aims at suppressing variations in the sequential access performances of storage devices.

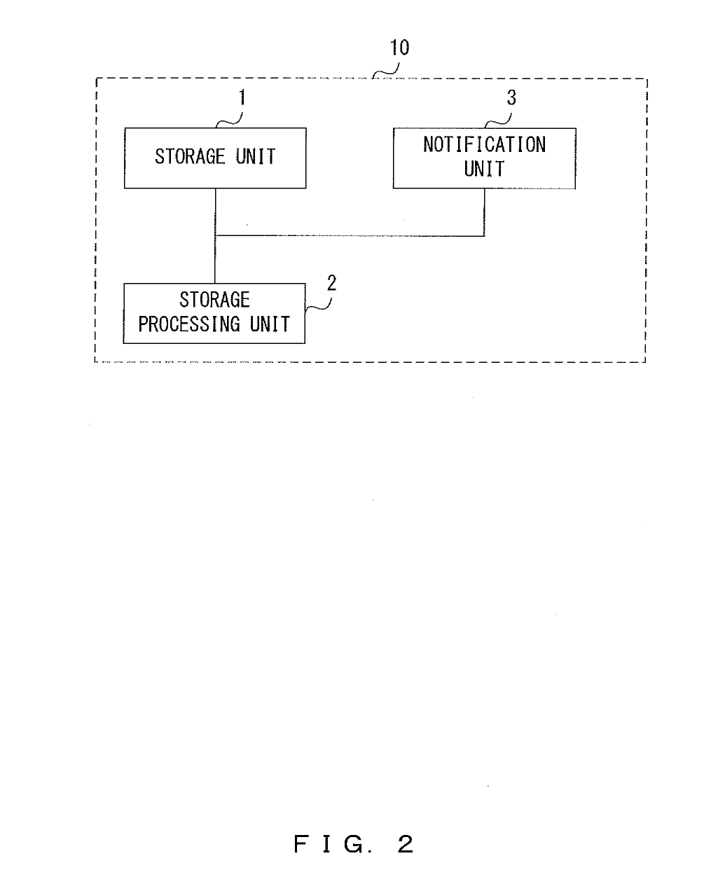

FIG. 2 is a functional block diagram illustrating a configuration of an implementation example of a server apparatus. In FIG. 2, the server apparatus 10 includes a storage unit 1, a storage processing unit 2, and a notification unit 3.

The storage unit 1 stores speed information about a speed of a sequential access to a storage area for each specified storage area of each of a plurality of storage devices.

The storage processing unit 2 selects at least two storage devices among the plurality of storage devices on the basis of an access request transmitted to any of the plurality of storage devices. The storage processing unit 2 identifies storage areas having a speed difference of a sequential access thereto, which is equal to or lower than a specified threshold value, in the selected storage devices by using speed information. The storage processing unit 2 stores data respectively in the identified storage areas.

Additionally, the storage processing unit 2 selects at least two storage devices among the plurality of storage devices in accordance with the number of redundancies of the plurality of storage devices on the basis of an access request transmitted to any of the plurality of storage devices. The storage processing unit 2 identifies a storage area having a speed difference of a sequential access thereto, which is equal to or lower than a specified threshold value, in the selected storage devices by using speed information. The storage processing unit 2 respectively stores data to be made redundant in the identified storage areas.

Furthermore, each of the storage areas identified by the storage processing unit 2 is a storage area of a combination having the highest speed among combinations of storage areas having a speed difference of a sequential access thereto, which is equal to or lower than the specified threshold value, in the selected storage devices.

Still further, the storage unit 1 stores information about an empty area of each storage area of each of the plurality of storage devices.

Still further, the storage processing unit 2 identifies a storage area, to which data can be written, on the basis of the information about an empty area. The storage processing unit 4 causes the data to be stored in storage areas of the selected storage devices among the identified storage areas.

The notification unit 3 notifies a different server apparatus 10 to write data when the storage area identified by the storage processing unit 2 is that of a storage device managed by a different server apparatus 10.

Such a server apparatus 10 can prevent a performance degradation caused by an access speed difference with the use of areas having a sequential access speed difference, which is equal to or smaller than a certain value, in disks to be made redundant.

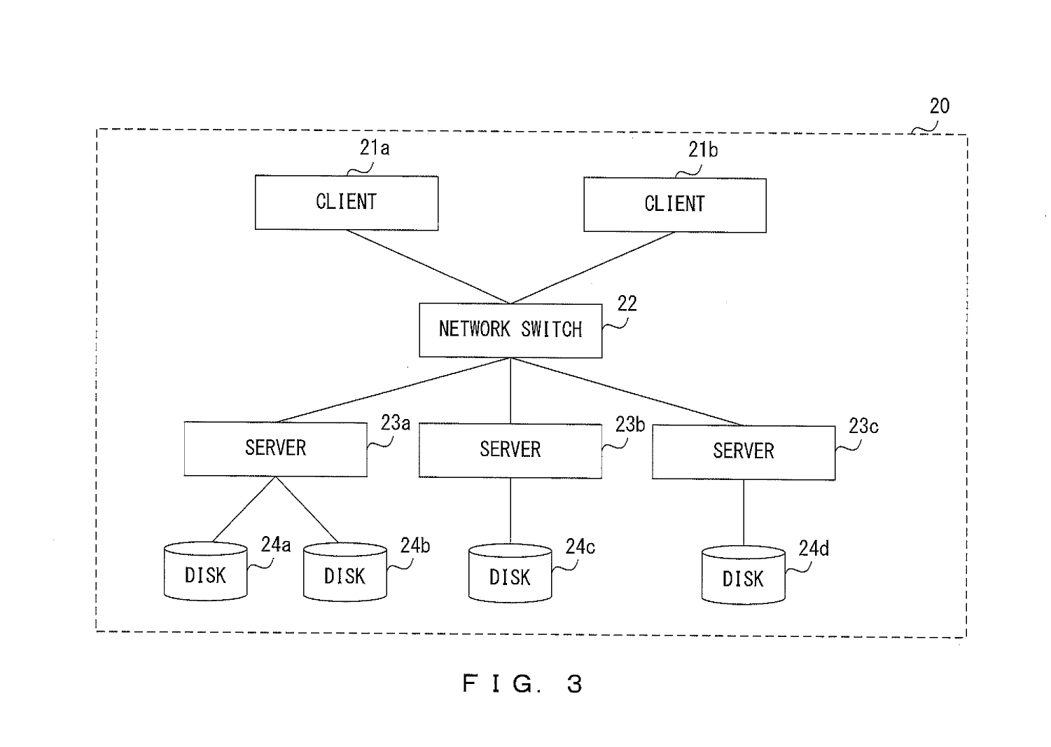

FIG. 3 illustrates an example of a configuration of a storage system according to the embodiment. In FIG. 3, the storage system 20 includes clients 21 (21a, 21b), a network switch 22, servers 23 (23a, 23b, 23c), and disks 24 (24a, 24b, 24c, 24d). The clients 21 and the network switch 22, and the network switch 22 and the servers 23 are respectively connected via a communication network (hereinafter referred to as a network). The servers 23 and the disks 24 are connected via a network, a bus or the like. The servers 23a, 23b and 23c are interconnected via a network such as the Ethernet or the like, a bus such as PCI (Peripheral Component Interconnect) Express or the like, a network, or the like. The numbers of the clients 21, network switches 22, the servers 23, and the disks 24 are not limited to those of the example illustrated in FIG. 3, and may be a specified number equal to or larger than 1. Moreover, a specified number of disks 24 equal to or larger than 1 may be connected to one server 23. Here, the server 23 is one example of the server apparatus 10.

The clients 21 are terminals that respectively transmit a request to read data stored in the disk 24, and receives the requested data from the server 23. Moreover, the clients 21 transmit, to the server 23, a write request including data to be written to the disk 24.

The network switch 22 is a relay device that relays a communication between the client 21 and the server 23. Moreover, the network switch 22 relays a communication among the server 23, the server 23b, and the server 23c.

The server 23 performs an access control for the disks 24 on the basis of a read or write request transmitted from the client 21. Upon receipt of the read request from the client 21, the server 23 reads data to be read from the disk 24, and transmits the read data to the client 21. Moreover, upon receipt of the write request from the client 21, the server 23 stores data to be written in the disk 24. The servers 23 respectively manage one or more disks 24 from or to which data is read or written, and control data input and output. For example, the server 23a manages the disks 24a and 24b, the server 23b manages the disk 24c, and the server 23c manages the disk 24d.

The disks 24 respectively store data to be written, which the client 21 requests to write. Specifically, the disks 24 are, for example, HDDs.

In the distributed storage system 20, data to be written, which the client 21 requests to write, is copied (made redundant) and stored in the plurality of disks 24. Moreover, the plurality of disks 24 may be combined, for example, like RAID (Redundant Arrays of Inexpensive Disks) or the like, and recognized as one logical disk for the client 21.

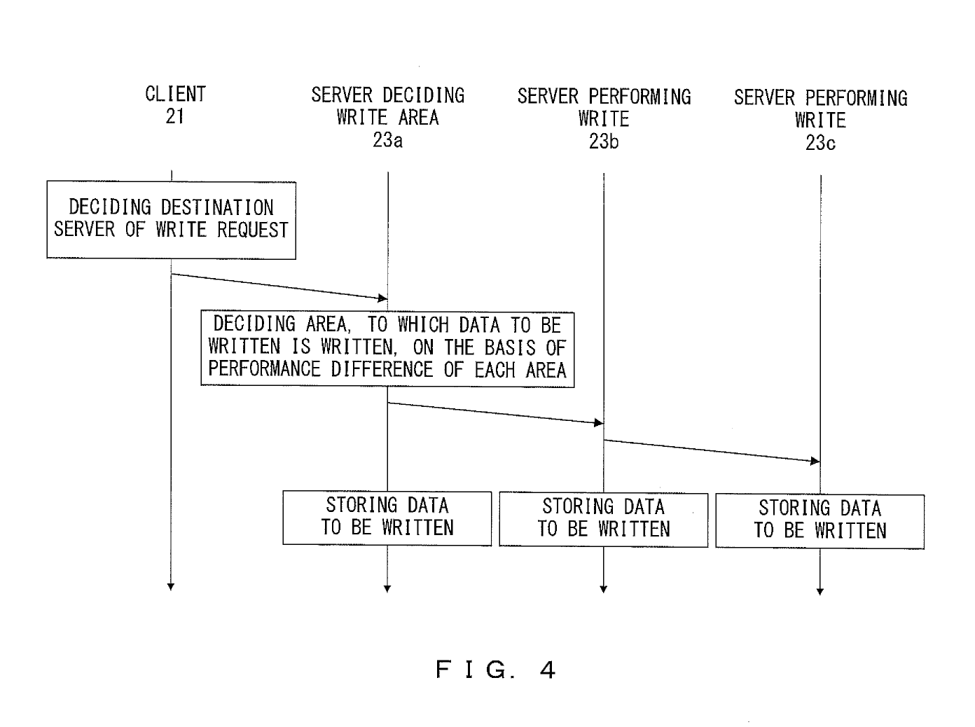

FIG. 4 is an explanatory diagram of operations performed when the write request is transmitted from the client 21 to the server 23.

The client 21 transmits the write request to any of the servers 23 when it writes data to any of the disks 24. At this time, to which server the write request is transmitted is decided in such a way that a preset server is designated as a destination. Alternatively, a destination may be decided on the basis of a hash value calculated from a name of data to be made redundant. The hash value may be calculated, for example, by using a hash function such as MD5 (Message Digest algorithm 5), SHA (Secure Hash Algorithm), or the like. One example of such a method for deciding a destination by using a hash value is consistent hashing. In the example illustrated in FIG. 4, the client 21 transmits the write request to the server 23a.

Any of the servers 23 that has received the data write request from the client 21 decides a disk in which data to be written is actually stored, and an area of the disk on the basis of a performance difference in areas of disks to be made redundant. Specifically, the server 23 decides a plurality of areas having a performance (speed) difference of a sequential access, which is equal to or lower than a specified threshold value, as areas in which the data to be written is stored. When the areas in which the data to be written is stored are present in a disk managed by the server that has decided the areas, the server that manages the disk including the area stores, in the areas, the data to be written. Alternatively, when the areas in which the data to be written is present in a disk managed by a different server, the server that has decided the areas issues, to the different server, an instruction to write the data to be written. The server that has received the write instruction stores the data to be written in the instructed area.

In FIG. 4, upon receipt of the write request, the server 23a decides areas in which the data to be written is stored. FIG. 4 illustrates the example where the disks 24a (or 24b), 24c and 24d are decided as the areas in which the data to be written is stored. In this case, the server 23a writes the data to be written to the disk 24a (or 24b) managed by the server 23a. Moreover, the server 23a issues an instruction to write the data to be written to the servers 23b and 23c. The servers 23b and 23c that have received the write instruction respectively store the data to be written in the instructed areas of the disks 23b and 23c. In FIG. 4, the write instruction is transmitted from the server 23a to the server 23c via the server 23b. However, the write instruction may be transmitted not via the server 23b.

Also for the read request, the client 21 can decide to which server 23 the read request is transmitted, similarly to the operations performed for the write request.

### First Embodiment

Methods for performing an access (a read or a write) from the client 21 to the disk 24 include a method for performing an access by designating a slice, and a method for performing an access via a file system. The first embodiment refers to a case where the client 21 performs an access by designating a slice. In the meantime, a second embodiment to be described later refers to a case where the client 21 performs an access via a file system.

With the method for performing an access by designating a slice, specifically, a user who uses the client 21 performs an access by directly designating a logical address to be accessed. Slices in the first embodiment indicate specified areas that are physically successive in a disk.

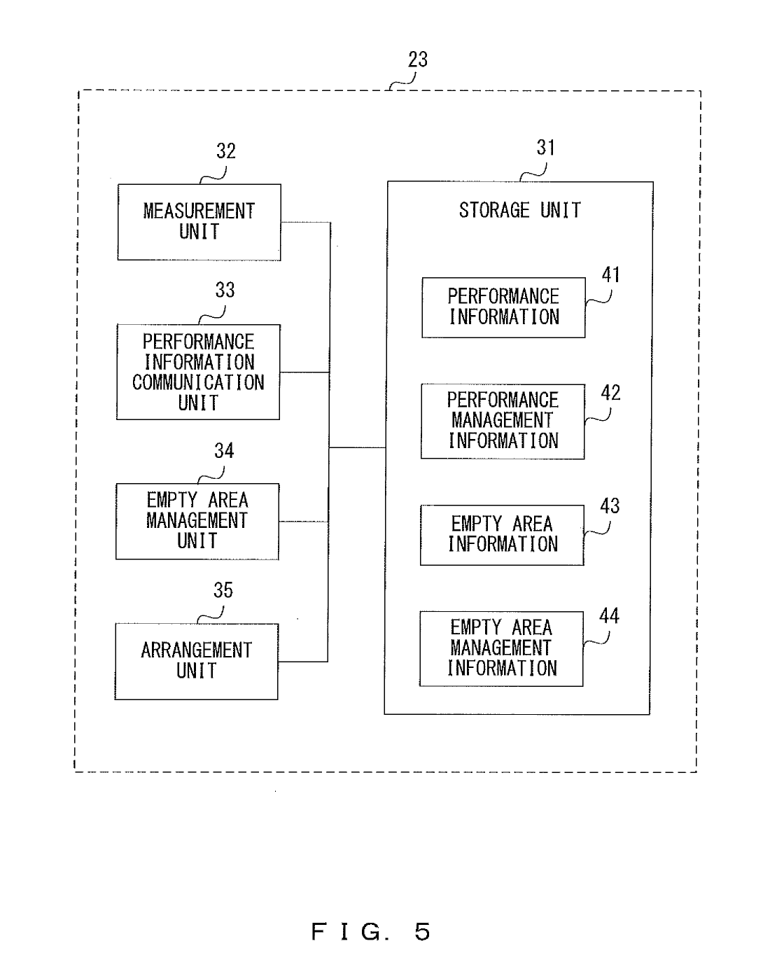

FIG. 5 illustrates an example of a configuration of the server 23 according to the first embodiment. The server 23 includes a storage unit 31, a measurement unit 32, a performance information communication unit 33, an empty area management unit 34, and an arrangement unit 35. The storage unit 31 is one example of the storage unit 1. The arrangement unit 35 is one example of the storage processing unit 2 and the notification unit 3.

The storage unit 31 stores performance information 41, performance management information 42, empty area information 43, and empty area management information 44. The storage unit 31 further stores information of various threshold values. Details of the information will be described later.

The measurement unit 32 measures a performance (speed) of a sequential access (a sequential write, a sequential read) of the disk 24. This measurement is performed in an initialization process executed for the server 23, and the disk 24 managed by the server 23. Specifically, the measurement unit 32 measures a speed difference in the sequential write performance in each specified area of each disk. Moreover, the measurement unit 32 measures a speed difference in the sequential read performance in each specified area of each disk.

Here, the sequential write performance is represented by a size of data sequentially written per unit time. The sequential read performance is represented by a size of data sequentially read per unit time. In the following explanation, the sequential write performance and the sequential read performance are referred to simply as a write performance and a read performance, respectively. Alternatively, the write performance, the read performance, or the write performance and the read performance are sometimes referred to simply as a performance or performances.

Specifically, the measurement unit 32 measures the write performance of each slice while sequentially writing data from the start to the end of each of all the disks 24 managed by each of the servers 23. The write performance of each slice is represented, for example, with an average value of the write performance of each slice.

Next, the measurement unit 32 measures the read performance of each slice while sequentially reading data from the start to the end of each of the disks 24. The read performance of each slice is represented, for example, with an average value of the read performance of each slice. Procedures of the measurements of the write performance and the read performance may be reverse. Moreover, the measurements of the write performance and the read performance can be implemented, for example, with a function of an OS (Operating System).

Then, the measurement unit 32 records the measured read performance and write performance in the performance information 41 stored in the storage unit 31. In the performance information 41, values that respectively indicate the measured write performance and read performance are associated with each other and recorded for each slice of each of the disks 24.

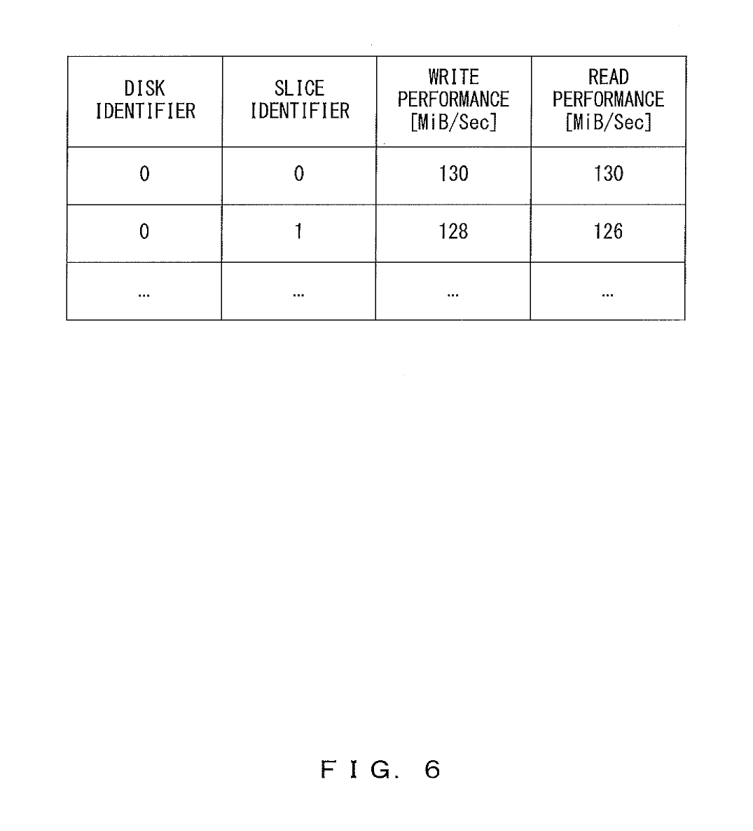

FIG. 6 illustrates an example of the performance information 41 according to the first embodiment. In FIG. 6, data entries such as a “disk identifier”, a “slice identifier”, a “write performance” and a “read performance” are associated with one another and stored in the performance information 41. The “disk identifier” is identification information of the disk 24 managed by the server 23. The “slice identifier” is identification information for uniquely identifying a slice of the disk 24 having a corresponding “disk identifier”. The “write performance” is a value that indicates the write performance of a slice having the “slice identifier” in the disk 24 having the corresponding “disk identifier”, and is an average value of the write performance of the corresponding slice. The “read performance” is a value that indicates the read performance of the slice having the “slice identifier” of the disk having the corresponding “disk identifier”, and is an average value of the read performance of the corresponding slice.

FIG. 6 depicts that, for example, the write performance and the read performance of a slice having the “slice identifier” indicated with “0” in the disk 24 having the “disk identifier” indicated with “0” are respectively “130 MiB/Sec”.

The performance information communication unit 33 provides a function of sharing the performance information 41 measured by the measurement unit 32 among all the servers that make the data redundant. In the example illustrated in FIG. 3, the performance information communication unit 33 provides the function of sharing the performance information 41 among the servers 23a, 23b, and 23c.

Specifically, the performance information communication unit 33 transmits the performance information 41 of the disk 24 managed by the server 23 that includes the performance information communication unit 33 to all the other redundant servers 23. Namely, for example, the server 23a transmits the performance information 41 of the disks 24a and 24b managed by the server 23a to the servers 23b and 23c.

Moreover, the performance information communication unit 33 receives the performance information 41 of the disks 24 managed by all the other redundant servers 23. Namely, for example, the server 23a receives the performance information 41 of the disk 24c from the server 23b, and also receives the performance information 41 of the disk 24d from the server 23c.

Additionally, the performance information communication unit 33 records the received performance information 41 in the performance management information 42. In the performance management information 42, the performance information 41 of all the redundant servers 23 are recorded. In the performance management information 42, an identifier of the server 23, and the performance information 41 measured by the server 23 are associated with each other and stored. For example, the performance information communication unit 33 may associate the received performance information 41 with a MAC (Media Access Control) address of a server at a transmission source of the performance information 41, and record them.

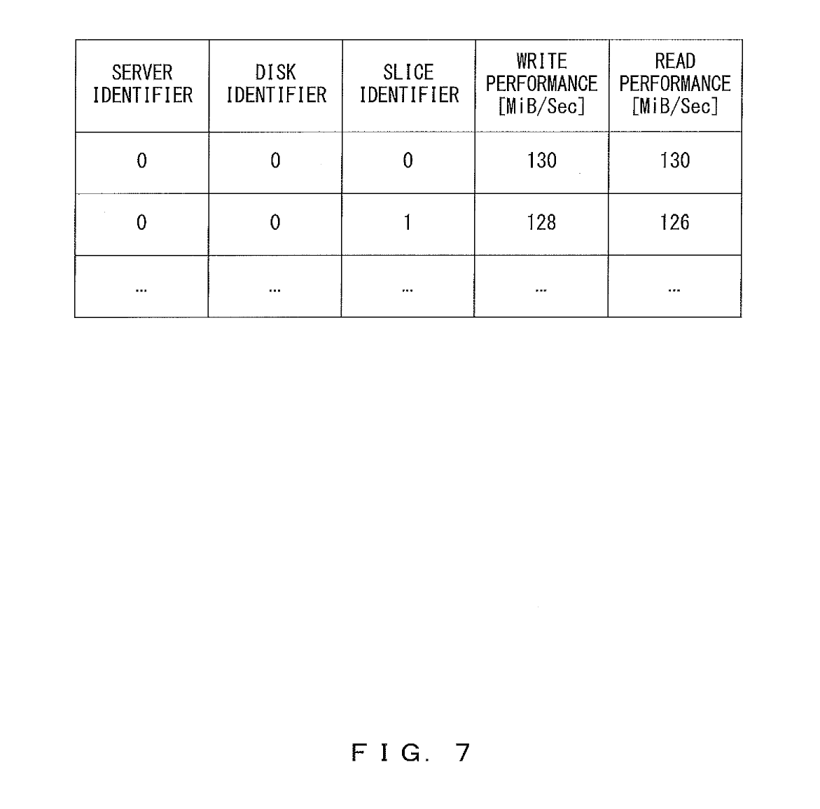

FIG. 7 illustrates an example of a structure of the performance management information 42 according to the first embodiment. In the performance management information 42, data entries such as a “server identifier”, a “disk identifier”, a “slice identifier”, a “write performance” and a “read performance” are associated with one another and stored. The “server identifier” is identification information for uniquely identifying a server. The data entries such as the “disk identifier”, the “slice identifier”, the “write performance” and the “read performance” are the same as those of the performance information 41 described with reference to FIG. 6. A combination of these data entries is the performance information 41 measured by the server 23 having the corresponding “server identifier”.

The empty area management unit 34 manages information that indicates a state of an empty area of each disk 24 managed by the server 23. Namely, the empty area management unit 34 stores, in the empty area information 43, information indicating whether an empty area is present in each specified area of each disk managed by the server 23. Moreover, when data is written or deleted to or from a specified area, the empty area management unit 34 reflects, on the empty area information 43, the state of the empty area of the specified area after the data is written or deleted to or from the specified area.

Specifically, information indicating whether a slice has been allocated is associated with each slice of each disk 24 and stored in the empty area information 43.

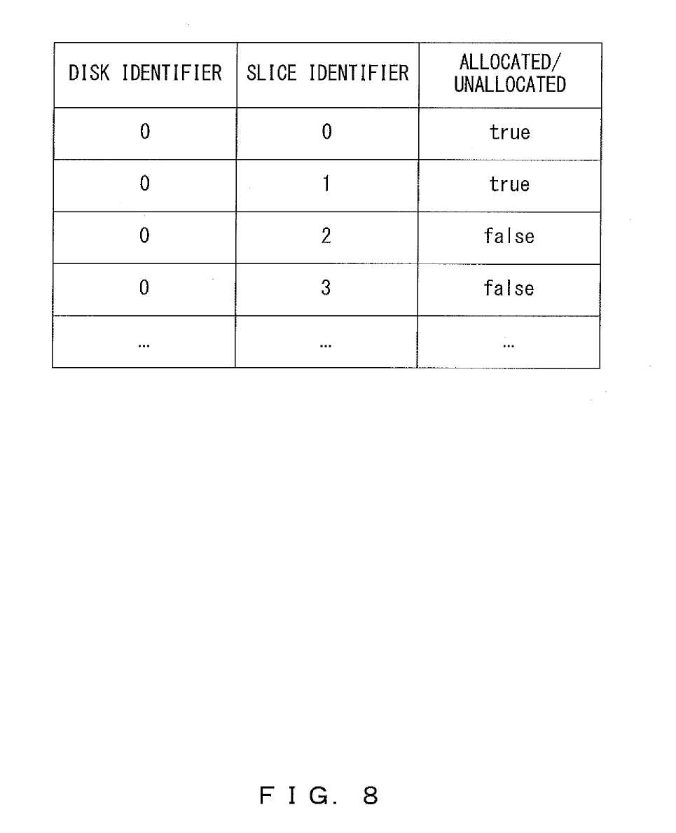

FIG. 8 illustrates an example of a structure of the empty area information 43 according to the first embodiment. In FIG. 8, in the empty area information 43, data entries such as a “disk identifier”, a “slice identifier” and “allocated/unallocated” are associated with one another and stored. The “disk identifier” is identification information of the disk 24 managed by the server 23. The “slice identifier” is identification information for uniquely identifying a slice of the disk 24 having a corresponding “disk identifier”. “allocated/unallocated” is information indicating whether a slice having a “slice identifier” of a disk having a corresponding “disk identifier” has been allocated. Here, an allocated state of a slice indicates a state in which data written from the client 21 is stored in the slice. When the slice has been allocated, “true” is stored in the “slice identifier”. When the slice has been unallocated, “false” is stored in the “slice identifier”.

FIG. 8 depicts that, for example, a slice having a slice identifier indicated with “0” in a disk 24 having a “disk identifier” indicated with “0” has been allocated.

Additionally, the empty area management unit 34 provides a function of sharing the empty area information 43 of each server 23 among all the servers 23 that makes the data redundant. Namely, the empty area management unit 34 collects the empty area information 43 of the disks 24 managed by all the other redundant servers 23.

In the collection of the empty area information 43, specifically, the empty area management unit 34 transmits a request to obtain the empty area information 43 to all the servers 23 in which the information is made redundant, and receives the empty area information 43 of each of the servers 23 as a response to the request. For example, the server 23a transmits the request to obtain the empty area information 43 to the servers 23b and 23c, obtains the empty area information 43 of the disk 24c from the server 23b as a response to the request, and also obtains the empty area information 43 of the disk 24d from the server 23c.

Furthermore, upon receipt of the request to obtain the empty area information 43 from a different server 23, the empty area management unit 34 transmits the empty area information 43 of the server 23 that includes the empty area management unit 34 to the server 23 at the request source of the empty area information 43. For example, upon receipt of the request to obtain the empty area information 43 from the server 23a, the server 23b transmits the empty area information 43 of the disk 24c to the server 23a.

The empty area management unit 34 records the received empty area information 43 in the empty area management information 44. In the empty area management information 44, the empty area information 43 of all the servers 23, in which the information is made redundant, are recorded, and an identifier of a server 23 and empty area information 43 of the disk 34 managed by the server 23 are associated with each other and stored. For example, the empty area management unit 34 may associate the received empty area information 43 with a MAC address of the server 23 at the transmission source of the empty area information 43, and record them.

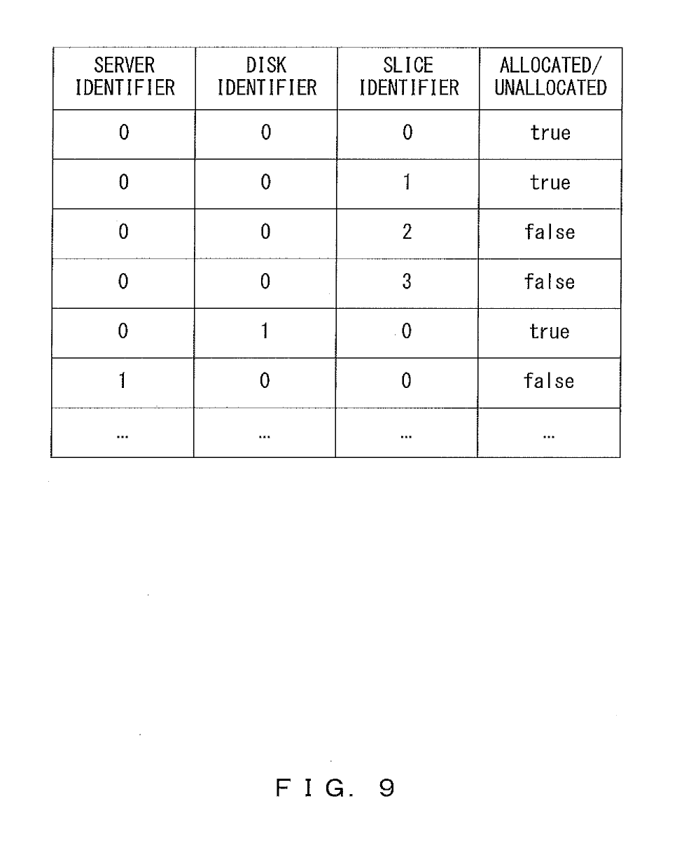

FIG. 9 illustrates an example of a structure of the empty area management information 44 according to the first embodiment. In the empty area management information 44, data entries such as a “server identifier”, a “disk identifier”, a “slice identifier” and “allocated/unallocated” are associated with one another and stored. The “server identifier” is identification information for uniquely identifying a server. A combination of the data entries such as the “disk identifier”, the “slice identifier” and “allocated/unallocated” is the empty area information 43 described with reference to FIG. 8, and is the empty area information 43 of a disk managed by a server having a corresponding “server identifier”.

Upon receipt of a write request from the client 21, the arrangement unit 35 executes a decision process for deciding an area in which data to be written is stored, and executes a storage process for storing the data to be written in the decided area.

The decision process is a process for deciding a disk 24 in which data to be written is stored, and an area of the disk 24, in which the data is stored. Here, disks 24 in which the data is stored may be decided by the number of redundancies. Moreover, the decision of areas in which the data is stored is performed on the basis of empty spaces of areas, and a performance difference among areas in which redundant data is stored.

In the decision process, the arrangement unit 35 initially decides disks 24 (referred to as target disks for the sake of an explanation) in which data to be written is stored. The number of target disks in which data to be written is stored is equal to that of redundancies. Namely, the number of target disks can be plural. The decision of target disks may be performed on the basis of various criteria. For example, disks managed by different servers may be selected as the target disks. Note that the target disks may be designated by a user in a write request. Moreover, the number of redundancies may be preset and stored in the storage unit 31, or designated by a user.

In the decision process, the arrangement unit 35 also identifies areas (hereinafter referred to as writable areas), in which data to be written can be stored, by using the empty area management information 44. Here, the writable areas indicate areas having an empty area of a size that can store the data to be written. In the first embodiment, the writable areas indicate slices that can store the data to be written (hereinafter referred to as writable slices).

Specifically, for example, the arrangement unit 35 identifies a writable slice by extracting, from the empty area management information 44, a row indicating that the value of “allocated/unallocated” represents “unallocated”.

Note that the selection of target disks may be performed after writable areas are identified. In this case, the arrangement unit 35 selects disks, the number of which is equal to that of redundancies, from a set of disks including any of the identified writable areas. In this way, the arrangement unit 35 can select disks having at least one writable area as target disks.

Next, the arrangement unit 35 generates a combination of writable areas by selecting one writable area respectively from the target disks. However, the arrangement unit 35 generates this combination of writable areas by selecting the areas so that the performances of the areas become a certain value or lower.

A plural number of combinations of writable areas having a performance equal to or lower than a certain value are sometimes present. In this case, the arrangement unit 35 selects one of the combinations in accordance with a specified criterion. As the specified criterion, various criteria are conceivable. An example where the arrangement unit 35 selects a combination in which one writable area has the highest performance is selected from among the combinations, and an example where a combination in which performances of all writable areas are equal to or higher than a specified threshold value and which has the smallest variance is selected are described here.

The case where the combination in which one writable area has the highest performance is selected from among the combinations is initially described. For example, the arrangement unit 35 firstly selects a slice having the highest performance (referred to as a slice x for the sake of an explanation) among writable slices of a specified disk (referred to as a disk X for the sake of the explanation) among target disks by referencing the performance management information 42. In the selection of the slice having the highest performance, specifically, the arrangement unit 35 selects, for example, a slice having the largest sum of a “write performance” and a “read performance” in the performance management information 42. Here, both the “write performance” and the “read performance” are taken into account. However, only either of the performances may be taken into account.

Next, the arrangement unit 35 identifies a slice that has a performance difference from the slice x, which is equal to or smaller than a specified threshold value, and also has the highest performance from among writable slices of each of the target disks other than the disk X by referencing the performance management information 42. Specifically, the arrangement unit 35 executes, for example, the following process for each of the target disks other than the disk X. Namely, the arrangement unit 35 initially extracts slices that have differences of values of the “write performance” and the “read performance” from the values of the “write performance” and the “read performance” of the slice x, which are equal to or smaller than a specified threshold value, in the performance information 42 from among the writable slices. Then, the arrangement unit 35 identifies a slice having the largest sum of the value of the “write performance” and that of the “read performance” among the extracted slices. Here, both the “write performance” and the “read performance” are taken into account. However, either of the “write performance” and the “read performance” may be taken into account.

Next, the arrangement unit 35 generates a combination of writable slices having a performance equal to or lower than a certain value by using the slice x and slices identified respectively for the target disks other than the disk X. Then, the arrangement unit 35 decides the slices included in the generated combination as areas in which data to be written is stored.

When the combination of writable slices having the performance equal to or lower than the certain value is not present among combinations including the slice x, the arrangement unit 35 similarly executes the process for generating a combination of slices having a performance equal to or lower than the certain value by selecting a slice having a performance second highest to the slice x among the writable slices of the disk X.

When a combination, in which one writable area has the highest performance, is selected from among combinations in this way, sequential data is written to areas having a high sequential performance. As a result, the performance of a sequential access can be improved. Namely, write data is written to an area having a low performance by performing a random access, and write data is written to areas having a high performance by performing a sequential access, whereby the access performance of the entire system can be improved. Moreover, in this case, whether a combination having a performance equal to or lower than a certain value is present is determined in descending order of performance. Therefore, it is not needed to execute the process for calculating a performance difference for all combinations, leading to reductions in the amount of the calculation.

The case where the combination in which the performances of all the slices are equal to or higher than a certain threshold value and which has the smallest variance is selected is described next. The specified threshold value for the performance of a slice may be included in a write request transmitted from the client 21, or may be prestored in the storage unit 31.

For example, the arrangement unit 35 initially generates a combination of slices by selecting slices having a performance equal to or higher than a specified threshold value from a set of writable slices in each of the target disks by referencing the performance management information 42. This combination of slices is generated for all possible combinations.

Next, the arrangement unit 35 calculates, for each generated combination of slices, a variance of values that indicate the write performances of slices, and a variance of values that indicate the read performances of the slices by referencing the performance management information 42. Then, the arrangement unit 35 identifies a combination having the smallest sum of the calculated variance of the write performances and that of the read performances. Then, the arrangement unit 35 decides slices included in the generated combination as areas in which data to be written is stored.

By selecting the combination having the smallest variance in this way, a performance difference among the disks 24 is minimized, so that an efficient disk layout can be implemented. Here, the combination having the smallest sum of the variance of the write performances and that of the read performances is identified. However, for example, a combination having the smallest value of the variance of the write performances or the read performances may be decided as areas in which data to be written is stored. In this case, data to be written can be stored in a combination of slices having the smallest difference of the write performance or the read performance. Moreover, for example, a combination having the largest sum of an average of the write performance or the read performance, or a combination having the largest sum of averages of the write performance and the read performance may be decided as areas in which data to be written is stored. In this case, data to be written can be stored in the combination of slices having the largest average of the write performance or the read performance. Moreover, for example, the arrangement unit 35 may decide any of combinations that has a variance equal to or lower than a specified threshold value, or a combination that has a variance equal to or smaller than a specified threshold value and also has the highest performance as areas in which the data to be written is stored.

Here, when the combination of slices having the performance difference equal to or smaller than the certain value is not present in the target disk, the arrangement unit 35 reselects another target disk, and similarly executes the decision process. When the combination of writable areas having the performance equal to or lower than the certain value is present in none of the target disks, the arrangement unit 35 decides a writable slice as an area in which data to be written is stored without taking into account a performance difference of each slice.

Note that the arrangement unit 35 may decide a combination of areas in which data to be written is stored by selecting areas the number of which is equal to that of redundancies after the arrangement unit 35 identifies in advance a combination of areas, which is generated by selecting areas respectively from the disks 24 and in which a performance difference of each area is equal to or smaller than the certain value.

After the arrangement unit 35 decides areas in which the data to be written is stored as described above, it executes a process for storing the data to be written in the decided areas. In the areas decided as those in which the data to be written is stored, the same data to be written, which is copied by the server 23 for redundancy, is stored.

In the storage process, when a different server manages a disk including a decided area, the arrangement unit 35 transmits a write instruction that includes storage position information indicating an area in which data to be written is stored and also includes the data to be written to a server that manages the disk including the decided area.

Upon receipt of the write instruction that includes the information indicating a write position and the data to be written from the different server, the arrangement unit 35 stores the data to be written in the write position included in the received instruction.

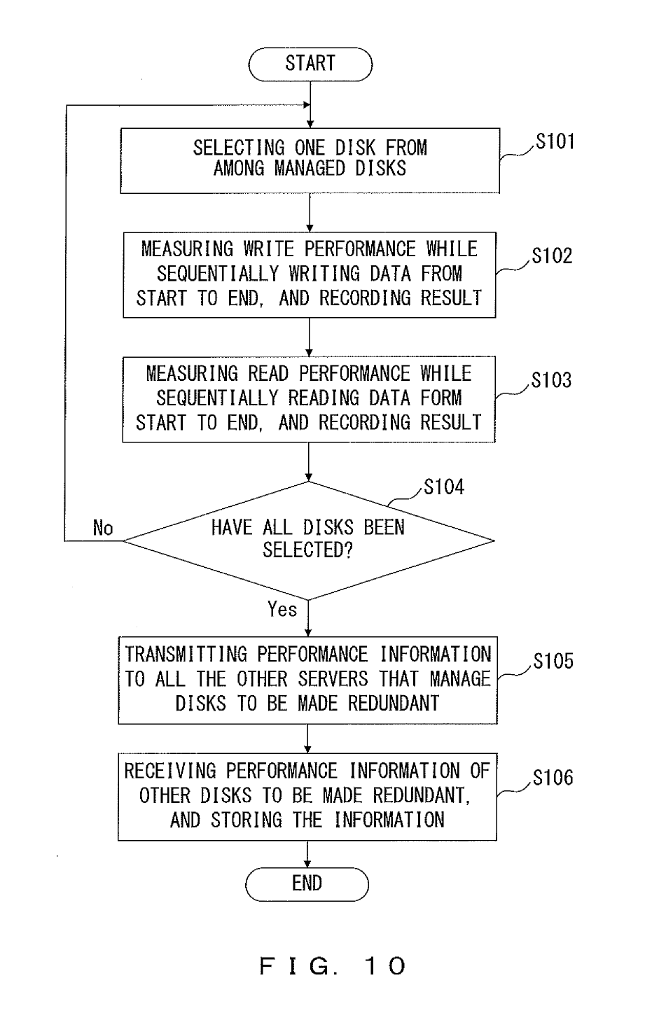

A flow of operations of measurements of a write performance and a read performance is described next. FIG. 10 is a flowchart illustrating details of the process for measuring the write performance and the read performance.

In FIG. 10, the measurement unit 32 initially measures one disk 24 from among disks 24 managed by a server (the server that executes the flow illustrated in FIG. 10. Referred to as a “server A1” for the sake of an explanation) 23 (S101).

Next, the measurement unit 32 measures the write performance while sequentially writing data from the start to the end of the disk 24 selected in S101. The measurement unit 32 records a result of the measurement in the performance information 41 (S102).

Next, the measurement unit 32 measures the read performance while sequentially reading the data from the start to the end of the disk 24 selected in S101 (S103). The measurement unit 32 records a result of the measurement in the performance information 41 (S103). Note that the order of S102 and S103 may be reverse.

Then, the measurement unit 32 determines whether all the disks 24 managed by the server A1 have been selected in S101 (S104). When the server A1 determines that any of the disks managed by the local server A1 has not been selected yet in S101 (“NO” in S104), the process returns to S101, in which the measurement unit 32 selects one disk 24 from among disks 24 that have not been selected yet (S101).

When the measurement unit 32 determines that all the disks 24 managed by the server A1 have been selected in S101 (“YES” in S104), the performance information communication unit 33 transmits the performance information 41 recorded in S102 and S103 to all the other servers 23 that manage disks to be made redundant (S105).

Next, the performance information communication unit 33 receives the performance information 41 of the other disks to be made redundant from the servers 23 that manage the other disks, and stores the performance information 41 in the performance management information 42 (S106). The process of S106 is a process for receiving the performance information 41 transmitted in S105 in the initialization process of the other servers 23 that make disks redundant. Accordingly, this process may be executed at a specified timing of the flow illustrated in FIG. 10, and the order of execution is not particularly limited. Then, the process is terminated.

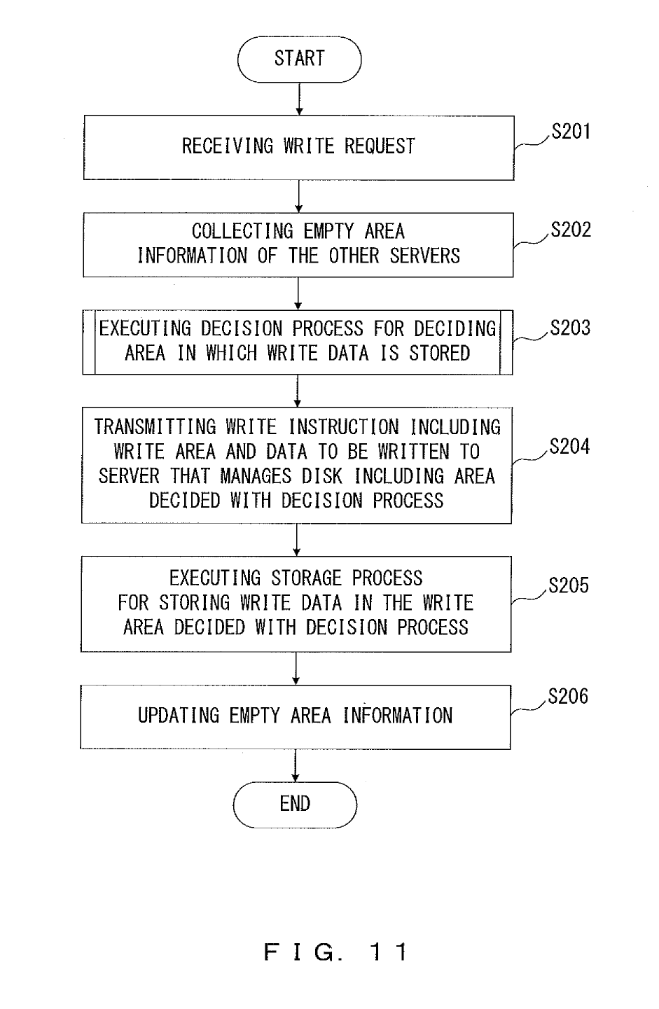

A flow of operations of the server 23 that decides a storage position in the write process is described next. FIG. 11 is a flowchart illustrating details of the write process for the server that decides a storage position, according to the embodiment. For convenience of an explanation, the server that executes the flow illustrated in FIG. 11 is referred to as a “server A2”.

In FIG. 11, the arrangement unit 35 of the server A2 receives a write request from the client 21 (S201). Here, the explanation is provided by assuming that the server 23 deciding a storage position receives the write request. However, the server 23 that receives a write request and the server that decides a storage position may differ. When the server 23 that receives a write request and the server that decides a storage position differ, S201 is an operation for receiving information indicating that the server deciding a storage position has received the write request from the server receiving the write request. The information indicating that the write request has been received is assumed to include information indicating the size of data to be written.

Next, the empty area management unit 34 collects empty area information 43 of disks managed by all the other servers (the servers different from the server A2 that executes the flow illustrated in FIG. 11), in which the disks are made redundant, and stores the collected information in the empty area management information 44 (S202). Namely, the empty area management unit 34 transmits a request to obtain the empty area information 43 to all the other servers that make the disks redundant, and receives the empty area information 43 of the disks respectively managed by the servers as a response to the request. Then, the empty area management unit 34 reflects content of the received empty area information 43 on the empty area management information 44.

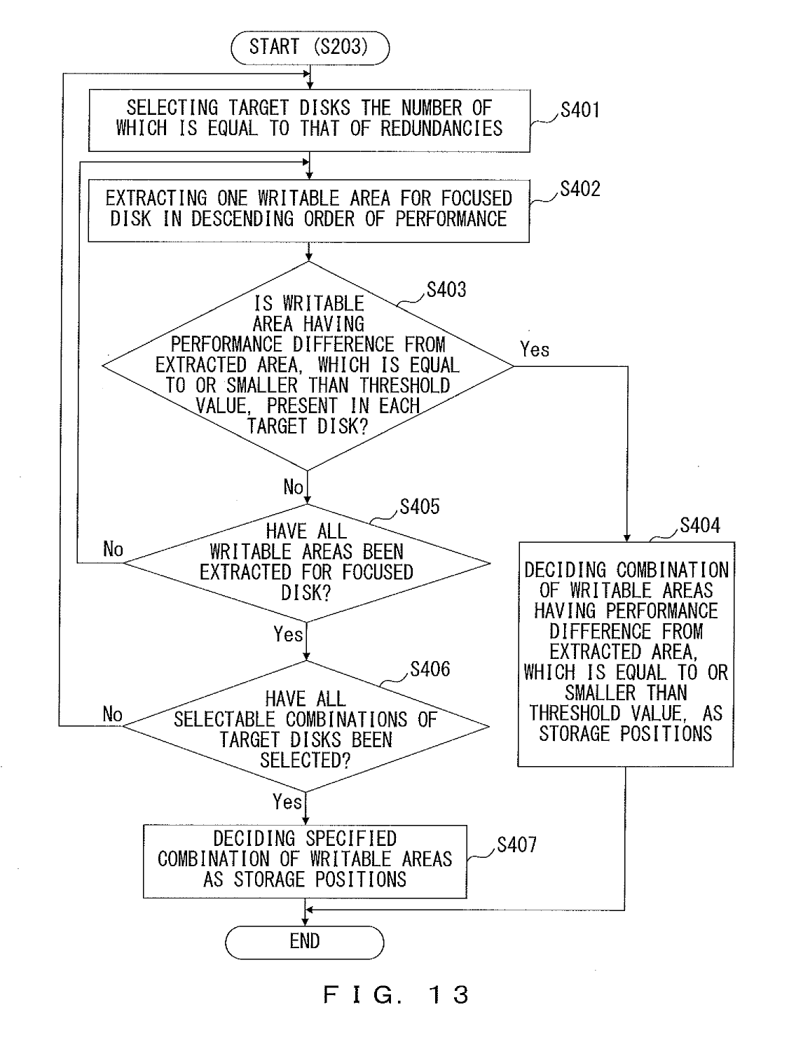

Next, the arrangement unit 35 executes the process for deciding an area in which data to be written included in the write request is stored (S203). Details of the decision process will be described later with reference to FIG. 13.

When an area of a disk managed by a different server is included in the areas decided with the decision process of S203, the arrangement unit 35 transmits a write instruction to the different server that manages the disk 24 including the area (S204). The write instruction includes the data to be written, and storage position information indicating an area in which the data to be written is stored. The different server that has received the write instruction stores the data to be written in the area indicated by the storage position information included in the write instruction.

Next, the arrangement unit 35 stores the data to be written in the area of the disk managed by the server A2 among the areas decided with the decision process of S203 (S205).

Then, the empty area management unit 34 updates the empty area information 43 about the area in which the data to be written is stored in S205 (S206). Then, the process is terminated.

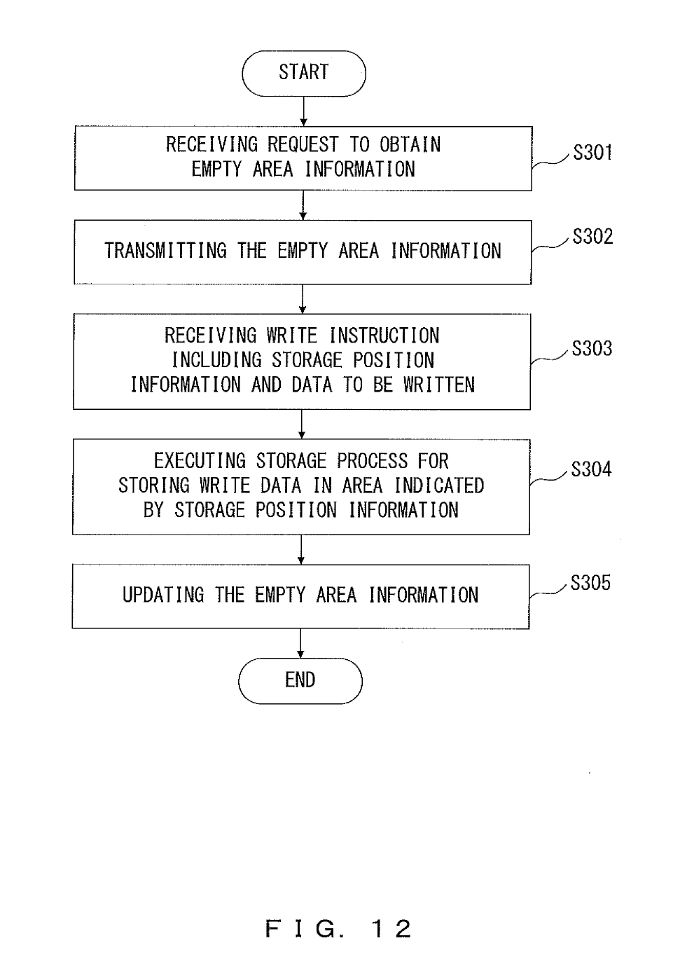

A flow of operations of the server that executes the write process upon receipt of a write instruction from the server that decides a storage position in the write process is described next. FIG. 12 is a flowchart illustrating details of the write process of the server that receives the write instruction from the server that decides a storage position and executes the write process, according to the embodiment. For convenience of an explanation, the server that executes the flow illustrated in FIG. 12 is referred to as a “server A3”.

In FIG. 12, the empty area management unit 34 of the server A3 initially receives a request to obtain the empty area information 43 from the server A2 that decides a storage position (S301).

Next, the empty area management unit 34 transmits the empty area information 43 of a disk managed by the server A3 to the server at the request source of the empty area information 43 (S302).

Then, the arrangement unit 35 receives, from the server A2 that decides a storage position, the write instruction including the data to be written and storage position information (S303).

Next, the arrangement unit 35 stores the data to be written in an area indicated by the storage position information included in the write instruction (S304).

Then, the empty area management unit 34 updates the empty area information 43 about the area in which the data to be written is stored in S302 (S305). Then, the process is terminated.

A flow of operations of details of the process for deciding a storage position, which is executed in S203 of FIG. 11, is described next. FIG. 13 is a flowchart illustrating the details of the process for deciding a storage position, according to this embodiment. An “area” described in FIG. 13 in the first embodiment specifically indicates a “slice”.

In FIG. 13, the arrangement unit 35 initially selects target disks, the number of which is equal to that of redundancies and in which data to be written is stored (S401). In one instance, the explanation is provided by assuming that the target disks selected here include a disk managed by the server A2 (the server that executes the flow illustrated in FIG. 13). However, the disk managed by the server A2 may not be included. Moreover, information of the disks selected as the target disks may be preset and stored in the storage unit 31, or may be included in a write request received from a user. Alternatively, information selected by a different server may be received as the information. In this case, S401 is omissible.

Next, the arrangement unit 35 extracts one area, which has the highest performance and in which data to be written can be stored, from among areas of one disk (for example, one target disk managed by the server A2) among the target disks selected in S401 (S402). A disk including the area extracted here is referred to as a “focused disk” for the sake of an explanation. Note that the arrangement unit 35 identifies the area, in which the write data can be stored, by referencing the empty area management information 44. Moreover, the arrangement unit 35 identifies a descending order of performances of areas of the target disk by referencing the performance management information 42. The performance referred to here indicates either or both of the write performance and the read performance as described above.

Next, the arrangement unit 35 determines whether an area (a writable area), which has a performance difference, equal to or smaller than a specified threshold value, from the extracted area and in which the data to be written can be stored, is present respectively in the target disks other than the focused disk (S403). Specifically, the arrangement unit 35 determines whether a writable area having a performance difference from the area extracted in S402, which is equal to or smaller than the specified threshold value, is present respectively in the target disks other than the focused disk by using the empty area management information 44 and the performance management information 42. Here, the arrangement unit 35 can identify a writable area respectively for the target disks by referencing the empty area management information 44. Moreover, the arrangement unit 35 can identify an area having a performance difference from the area extracted in S403, which is equal to or smaller than the specified threshold value, by referencing the performance management information 42.

In S403, when the arrangement unit 35 determines that the writable area having the performance difference from the extracted area, which is equal to or smaller than the specified threshold value, is present respectively in the target disks other than the focused disk (“YES” in S403), the arrangement unit 35 executes the following process. Namely, the arrangement unit 35 decides a combination of the area extracted in S402 and the writable area having the performance difference from the extracted area, which is equal to or smaller than the certain value, in each of the target disks as a combination of areas (write positions) in which the write data is stored (S404). Specifically, the arrangement unit 35 initially identifies the writable area having the performance difference from the area extracted in S402, which is equal to or smaller than the certain value, respectively for the target disks other than the focused disk. When a plural number of identified areas are present in each of the disks, the arrangement unit 35 selects one of the identified areas. For example, the arrangement unit 35 may select one area having the highest performance from among the plurality of areas, or may select one area having the lowest performance from among the areas extracted in S402. In this way, a combination of one area selected for each of the target disks other than the focused disk and the area extracted in S402 is decided as a combination of areas of write positions in which data to be written is stored. Then, the process is terminated.

When the arrangement unit 35 determines that the writable area having the performance difference from the extracted area, which is equal to or smaller than the specified threshold value, is present in none of the target disks other than the focused disk (“NO” in S403), the arrangement unit 35 executes the following process. Namely, the arrangement unit 35 determines whether all the writable areas have been extracted for the focused disk in S402 (S405).

When the arrangement unit 35 determines that any of the writable areas has not been extracted yet in S402 for the target disk managed by the server A2 (“NO” in S405), the process returns to S402. Then, again in S402, the arrangement unit 35 extracts a writable area having the highest performance from among areas that have not been extracted yet (S402).

When the arrangement unit 35 determines that all the writable areas have been extracted in S402 for the focused disk (“YES” in S405), the process proceeds to S406.

Next, the arrangement unit 35 determines whether all selectable combinations of target disks have been selected in S401 (S406). When the arrangement unit 35 determines that any of the selectable combinations has not been selected yet (“NO” in S406), the process returns to S401. Then, again in S401, the arrangement unit 35 selects target disks the number of which is equal to that of redundancies. A combination of target disks selected here is a combination that has not been selected yet.

In S406, when the arrangement unit 35 determines that all the selectable combinations have been selected in S401 (“YES” in S406), the process proceeds to S407.

Next, the arrangement unit 35 decides a specified combination of writable areas as a combination of areas of write positions in which data to be written is stored (S407). In the selection of a combination of areas of write positions in S407, the arrangement unit 35 does not take into account a performance difference of each area. Then, the process is terminated.

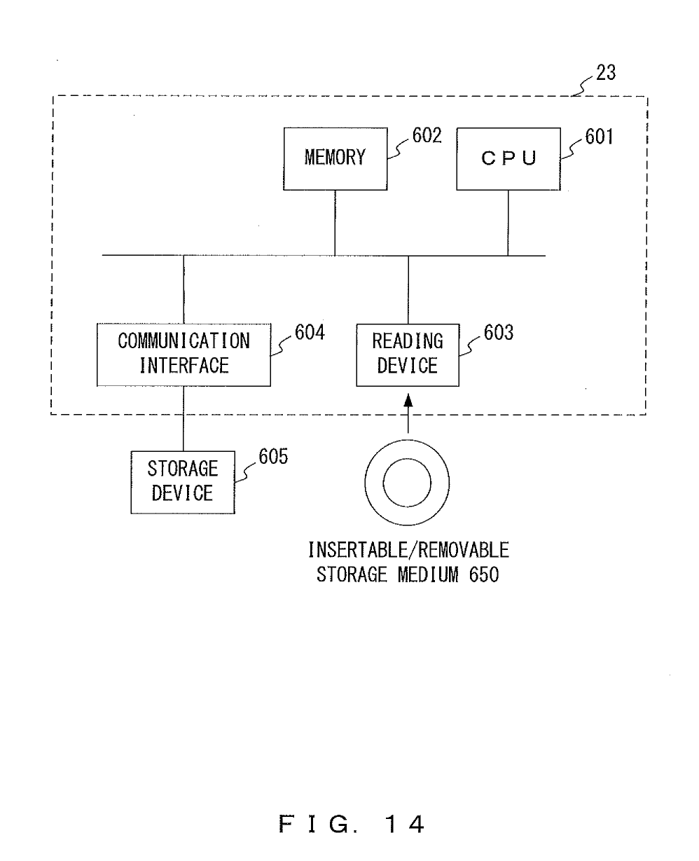

A hardware configuration of the server is described next. FIG. 14 illustrates an example of the hardware configuration of the server according to the embodiment.

In FIG. 14, the server 23 includes a CPU (Central Processing Unit) 601, a memory 602, a reading device 603 and a communication interface 604. The CPU 601, the memory 602, the reading device 603 and the communication interface 604 are interconnected via a bus. Moreover, the server 23 is connected to one or more storage devices 605 via a network or a bus. The storage device 605 may be included in the server 23.

The CPU 601 provides some or all of the functions of the measurement unit 32, the performance information communication unit 33, the empty area management unit 34 and the arrangement unit 35 by executing a program that describes the above described steps of the flowcharts with the use of the memory 602.

The memory 602 is, for example, a semiconductor memory, and configured by including a RAM (Random Access Memory) area and a ROM (Read Only Memory) area. The memory 602 provides some or all of the functions of the storage unit 31.

The reading device 603 accesses an insertable/removable recording medium 650 in accordance with an instruction of the CPU 601. The insertable/removable storage medium 650 is implemented, for example, with a semiconductor device (a USB memory or the like), a medium (a magnetic disk or the like) to or from which information is input or output with a magnetic action, a medium (a CD-ROM, a DVD or the like) to or from which information is input or output with an optical action, or the like. The reading device 603 may not be included in the server 23.

The communication interface 604 communicates with the client 21, other servers 23, and the storage device 605 via the network in accordance with an instruction of the CPU 601.

The program according to this embodiment is provided to the server 23, for example, in the following forms.

(1) Preinstalled in the memory 602.
(2) Provided by the insertable/removable storage medium 650.
(3) Provided from a program server (not illustrated) via the communication interface 604.

The storage device 605 is, for example, a hard disk. The storage device 605 is one example of the disk 24.

Additionally, some of the servers 23 according to the embodiment may be implemented with hardware, or the servers 23 according to the embodiment may be implemented with a combination of software and hardware.

### Second Embodiment

Methods for performing an access (a read or a write) from the client 21 to the disk 24 include the method for performing an access by designating a slice, and the method for performing an access via a file system. The first embodiment refers to the case where an access from the client 21 is performed by designating a slice. The second embodiment refers to a case where an access from the client 21 is performed via a file system.

The file system is a mechanism for managing and operating data stored in disks. In the file system, for example, methods for creating, deleting or moving a file or a folder (a directory), a scheme for recording data in a disk, a site of a management area and a method using the management area, and the like are defined. In the second embodiment, for example, a distribution file system in which a plurality of clients 21 can perform an access while sharing files of disks 24 via a network may be used.

The clients 21 logically divide and use a storage area of a disk. The individual areas into which the storage area of the disk is divided are partitions. In the individual partitions, different file systems may be created.

The second embodiment assumes that an access, a write and a read of data are performed via the file system.

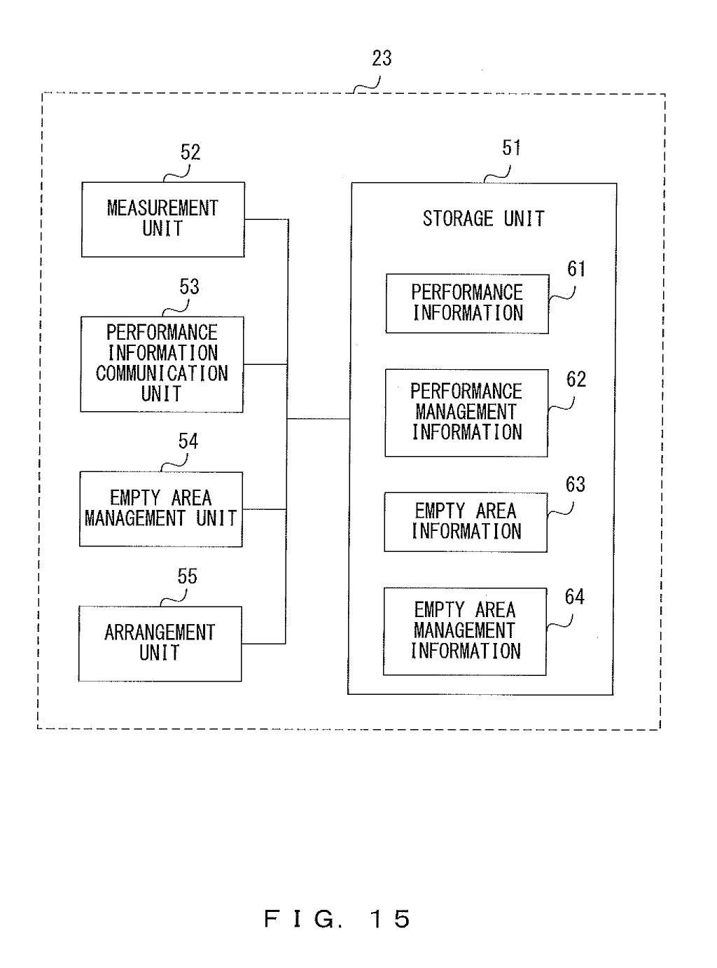

FIG. 15 illustrates an example of a configuration of the server 23 according to the second embodiment. The server 23 includes a storage unit 51, a measurement unit 52, a performance information communication unit 53, an empty area management unit 54 and an arrangement unit 55. The storage unit 51 is one example of the storage unit 1. The arrangement unit 55 is one example of the storage processing unit 2 and the notification unit 3.

The storage unit 51 stores performance information 61, performance management information 62, empty area information 63 and empty area management information 64. Details of these items of information will be described later.

The measurement unit 52 measures performances of a sequential access in an initialization process for the server 23, and a disk 24 managed by the server 23. Namely, the measurement unit 52 measures a speed difference of a sequential write performance of each specified area in each disk. Moreover, the measurement unit 52 measures a speed difference of a sequential read performance of each specified area in each disk.

Specifically, the measurement unit 52 initially creates an empty file in each of all the partitions of all the disks that the server uses as a storage. Next, the measurement unit 52 measures a write performance while sequentially writing data to each created file. The measurement unit 52 repeatedly writes the data to the file and measures the write performance until no more file can be stored in a partition in accordance with a size of the file. For example, the measurement unit 52 repeatedly writes the data and measures the write performance until the size of the file reaches that of the partition.

Next, the measurement unit 52 measures the read performance while sequentially reading the data from the start to the end of the file.

Then, the measurement unit 52 records the measured write and read performances in the performance information 61 stored in the storage unit 51. In the performance information 61, values that respectively indicate the measured write and read performances are associated with each partition of each disk and stored.

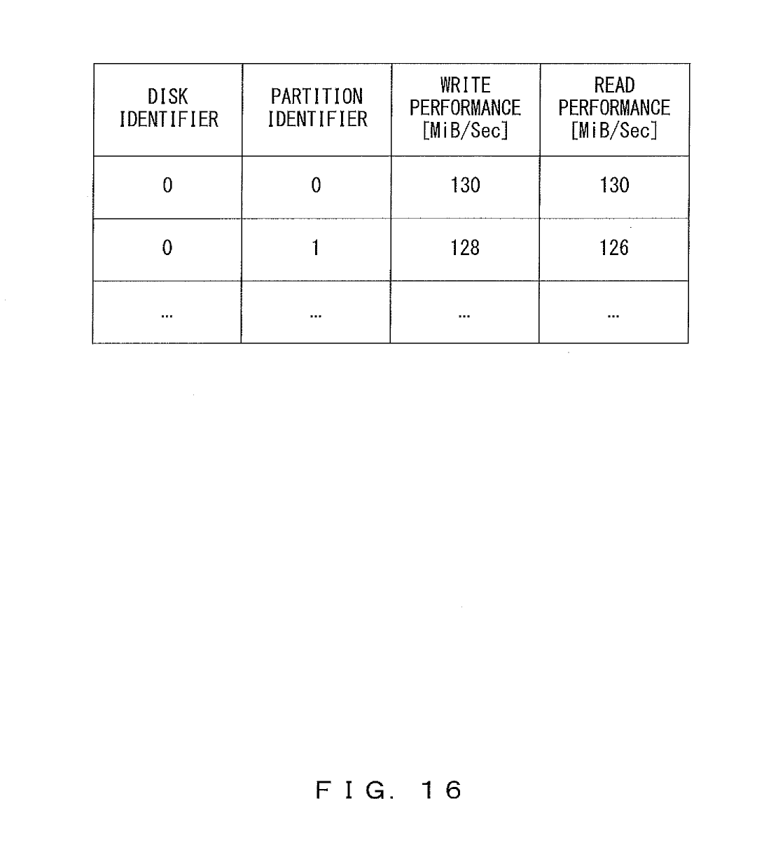

FIG. 16 illustrates one example of the performance information 61 according to the second embodiment. In FIG. 16, in the performance information 61, data entries such as a “disk identifier”, a “partition identifier”, a “write performance”, and a “read performance” are associated with one another and stored. The “disk identifier” is identification information of a disk managed by a server. The “partition identifier” is identification information for uniquely identifying a partition of a disk having a corresponding “disk identifier”. The “write performance” is a value indicating a write performance to a partition having a “partition identifier” of a disk having a corresponding “disk identifier”, and is an average value of the write performance of the corresponding partition. The “read performance” is a value indicating a read performance from the partition having the “partition identifier” of the disk having the corresponding “disk identifier”, and is an average value of the read performance of the corresponding partition.

FIG. 16 depicts that, for example, the write performance and the read performance of a partition having a “partition identifier” indicated with “0” in a disk having a “disk identifier” indicated with “0” are respectively “130 MiB/Sec”.

The performance information communication unit 53 performs operations similar to those of the performance information communication unit 33 according to the first embodiment. However, communicated information is the performance information 61. In relation to this, an identifier of a server, and performance information 61 measured by the server are associated with each other and stored in the performance management information 62.

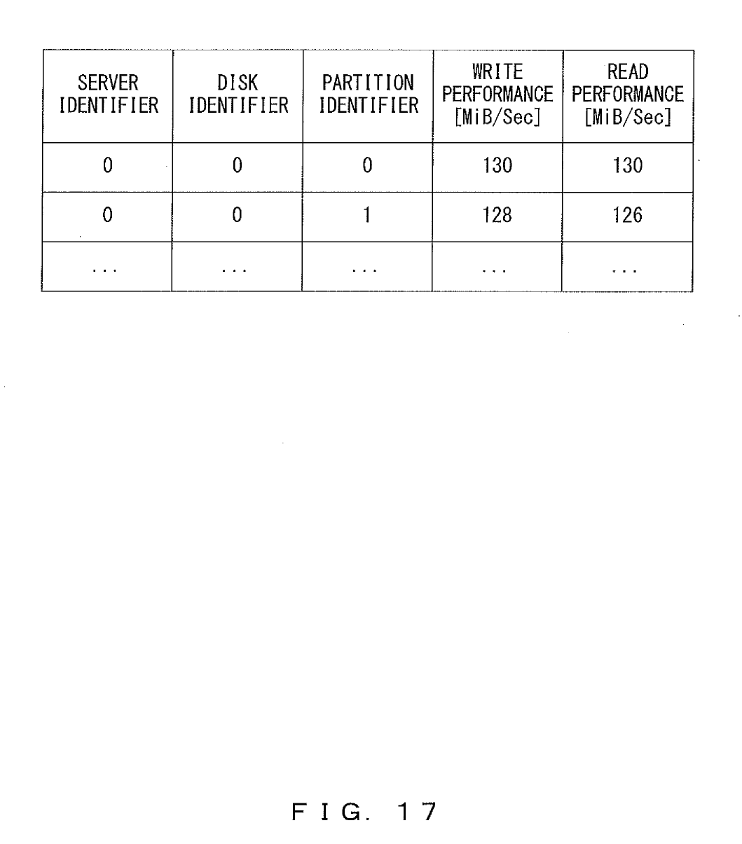

FIG. 17 illustrates an example of a structure of the performance management information 62 according to the second embodiment. In FIG. 17, data entries such as a “server identifier”, a “disk identifier”, a “partition identifier”, a “write performance” and a “read performance” are associated with one another and stored in the performance management information 62. The “server identifier” is identification information for uniquely identifying a server. The data entries such as the “disk identifier”, the “partition identifier”, the “write performance” and the “read performance” are similar to those of the performance information 61 described with reference to FIG. 16, and a combination of these data entries is the performance information 61 measured by a server having a corresponding “server identifier”.

Similarly to the empty area management unit 34 according to the first embodiment, the empty area management unit 54 manages information indicating a state of an empty area of each disk managed by a server. Namely, the empty area management unit 54 records, in the empty area information 63, information indicating a size of an empty area of each specified area in each disk managed by the server. Moreover, when data is written or deleted to or from a specified area, the empty area management unit 54 reflects, on the empty area information 63, a state of an empty area of the specified area after the data is written or deleted.

Specifically, information indicating an empty space of a partition is associated with each partition of each disk and stored in the empty area information 63.

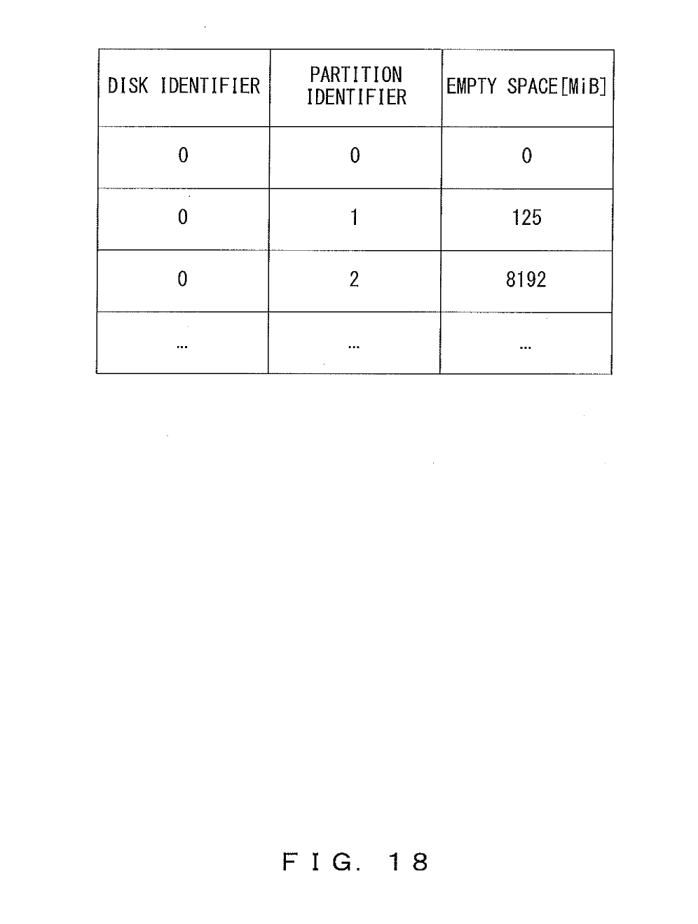

FIG. 18 illustrates an example of a structure of the empty area information 63 according to the second embodiment. In FIG. 18, data entries such as a “disk identifier”, a “partition identifier” and an “empty space” are associated with one another and stored in the empty area information 63. The “disk identifier” is identification information of a disk managed by a server. The “partition identifier” is identification information for uniquely identifying a partition of a disk having a corresponding “disk identifier”. The “empty space” is information indicating an empty space of a partition having a “partition identifier” in a disk having a corresponding “disk identifier”.

FIG. 18 depicts that, for example, an empty space of a partition having a “partition identifier” indicated with “0” in a disk having a “disk identifier” indicated with “0” is “0 MiB”.

Moreover, similarly to the empty area management unit 34 according to the first embodiment, the empty area management unit 54 provides a function of sharing the empty area information 63 of each server among all the servers that make the data redundant. However, communicated information is the empty area information 63. In related to this, an identifier of a server, and the empty area information 63 of a disk managed by the server are associated with each other and stored in the empty area management information 64.

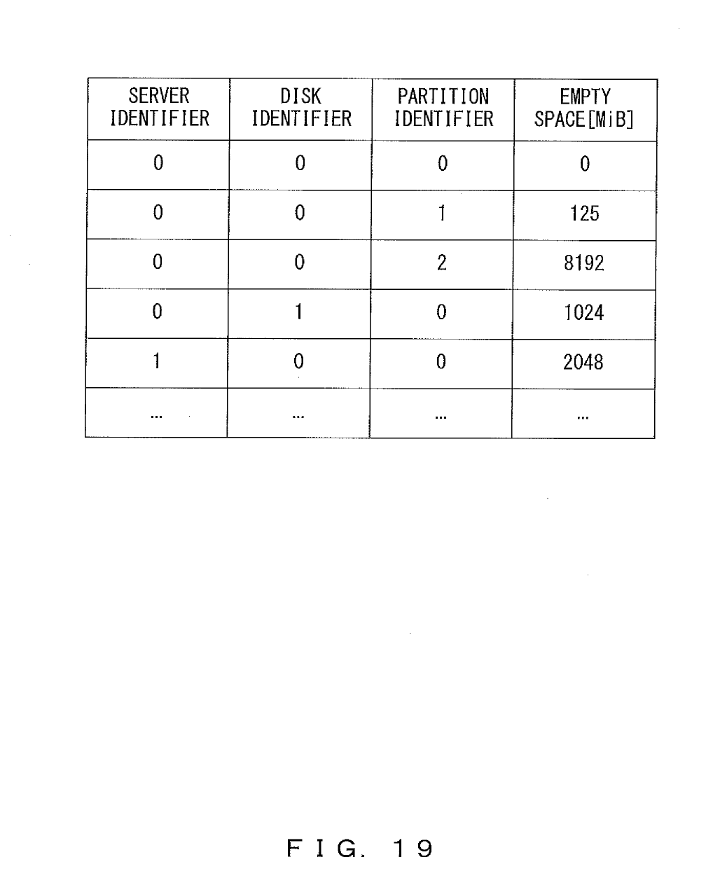

FIG. 19 illustrates an example of a structure of the empty area management information 63 according to the second embodiment. In FIG. 19, data entries such as a “server identifier”, a “disk identifier”, a “partition identifier” and an “empty space” are associated with one another and stored in the empty area management information 64. The “server identifier” is identification information for uniquely identifying a server. A combination of the data entries such as the “disk identifier”, the “partition identifier” and the “empty space” is the empty area information 63 described with reference to FIG. 18, and is the empty area information 63 of a disk managed by the server having a corresponding “server identifier”.

Upon receipt of a write request from the client 21, the arrangement unit 55 executes a decision process for deciding an area in which data to be written is stored, and also executes a storage process for storing the data to be written in the decided area.

The decision process is a process for deciding a disk in which data to be written is stored, and an area of the disk, in which the data is stored. Here, disks in which the data is stored may be decided by a number equal to that of redundancies. Moreover, the decision of the areas in which the data is stored are performed on the basis of a determination of whether the data to be written can be stored in the areas, and a performance difference among the areas in which redundant data is stored.

In the decision process, the arrangement unit 55 initially decides a disk in which data to be written is stored (referred to as a target disk for the sake of an explanation). The number of target disks in which data to be written is stored is equal to that of redundancies. Namely, the number of target disks can be plural. The decision of target disks may be performed on the basis of various criteria. For example, disks managed by different servers may be selected as the target disks. Note that the target disks may be designated by a user in a write request. Moreover, the number of redundancies may be preset and stored in the storage unit 51, or may be designated by a user.

In the decision process, the arrangement unit 55 identifies an area (writable area), in which data to be written can be stored, by using the empty area management information 64. Specifically, the arrangement unit 55 identifies a writable area, for example, by extracting a row in which the value of the “empty space” in the empty area management information 64 is larger than the data to be written. In the second embodiment, a writable area indicates a partition (hereinafter referred to as a writable partition) in which data to be written can be stored.

Note that the selection of target disks may be performed after writable areas are identified. In this case, the arrangement unit 55 selects disks, the number of which is equal to that of redundancies, from a set of disks including any of the identified writable areas.

Next, the arrangement unit 55 generates a combination of writable areas by selecting one writable area respectively from the target disks. Note that, however, the arrangement unit 55 generates this combination of writable areas by selecting the areas so that performances of the areas become a certain value or lower.

A plurality of combinations of writable areas having a performance equal to or lower than the certain value are present in some cases. In this case, the arrangement unit 55 selects one of the combinations in accordance with a specified criterion. As the specified criterion, various ones are conceivable. Here, an example where the arrangement unit 55 selects a combination in which the performance of one writable area is the highest is selected from among the combinations, and an example where a combination in which performances of all the writable areas are equal to or higher than a specified threshold value and which has the smallest variance is selected are described.

The case where the combination in which the performance of one writable area is the highest is selected from among the combinations is initially described. For example, the arrangement unit 55 initially selects a partition (referred to as a “partition y” for the sake of an explanation) having the highest performance is selected from among writable partitions for a specified disk (referred to as a disk Y for the sake of the explanation) among the target disks. In the selection of the partition having the highest performance, specifically, the arrangement unit 55 selects, for example, a partition having the largest sum of a “write performance” and a “read performance” in the performance management information 62. Here, both the “write performance” and the “read performance” are taken into account. However, either of the performances may be taken into account.

Then, the arrangement unit 55 identifies a partition that has a performance difference from the partition y, which is equal to or smaller than a specified threshold value, and also has the highest performance from among writable partitions of each of the target disks other than the disk Y. Specifically, the arrangement unit 55 executes, for example, the following process for each of the target disks other than the disk Y. Namely, the arrangement unit 55 initially extracts a partition having differences of values of the “write performance” and the “read performance” from those of the “write performance” and the “read performance” of the partition y in the performance information 62 from among the writable partitions. Then, the arrangement unit 55 identifies a partition having the largest sum of the “write performance” and the “read performance” from among extracted partitions. Here, both the “write performance” and the “read performance” are taken into account. However, either of the performances may be taken into account.

Then, the arrangement unit 55 generates a combination of writable partitions having a performance equal to or lower than a certain value by combining the partitions identified for each of the target disks and the partition y.

When a combination having the performance equal to or lower than the certain value is not present among the partitions including the partition y, the arrangement unit 55 selects a partition having the second highest performance among the writable partitions of the disk Y, and similarly executes the process for generating a combination of partitions having the performance equal to or lower than the certain value.

The case where the combination in which the performances of all the partitions are equal to or higher than the specified threshold value and which has the smallest variance is selected is described next. The specified threshold value for the performance of a partition may be included in a write request from the client 21, or may be prestored in the storage unit 51.

For example, the arrangement unit 55 initially generates a combination of partitions by selecting one partition having a performance equal to or higher than a specified threshold value from a set of writable partitions in each of the target disks with reference to the performance management information 62. A combination of partitions is generated for all possible combinations.

Next, the arrangement unit 55 calculates a variance of values that indicate the write performances of partitions, and a variance of values that indicate the read performances of partitions for each generated combination of partitions by referencing the performance management information 62. Then, the arrangement unit 55 identifies a combination having the smallest sum of the calculated variance of the write performances and that of the read performances. Next, the arrangement unit 55 decides partitions included in the generated combination as areas in which data to be written is stored.

As describe above, a combination having the smallest variance is selected, so that a performance difference among disks is minimized. As a result, an efficient disk layout can be implemented. Here, the combination having the smallest sum of the variance of the write performances and the variance of the read performances is identified. Alternatively, for example, a combination having the smallest value of the variance of the write performances or the read performances may be decided as areas in which data to be written is stored. In this case, the data to be written can be stored in the combination of partitions having the smallest difference of the write performance or the read performance. Further alternatively, for example, a combination having an average of the write performance, an average of the read performance, or the sum of averages of the read and the write performances may be decided as areas in which data to be written is stored. In this case, the data to be written can be stored in a combination of partitions having the largest average of the write performance or the read performance. Moreover, for example, the arrangement unit 55 may decide, as areas in which data to be written is stored, any of combinations having a variance equal to or smaller than a specified threshold value, or a combination that has a variance equal to or smaller than a specified threshold value and also has the highest performance.

Here, when a combination having a performance difference of each partition, which is equal to or smaller than a certain value, is not present in a target disk, the arrangement unit 55 reselects another target disk, and similarly executes the decision process. When the combination of writable areas having the performance equal to or lower than the certain value is present in none of the target disks, the arrangement unit 55 decides a writable partition as an area in which data to be written is stored without taking a performance difference of each partition into account.

Note that the arrangement unit 55 may decide a combination of areas in which data to be written is stored by selecting areas the number of which is equal to that of redundancies after the arrangement unit 55 identifies in advance a combination of areas, which is generated by selecting one area respectively from the disks and in which a performance difference of each of the areas is equal to or smaller than the certain value.

After the arrangement unit 55 decides areas in which data to be written is stored as described above, it executes the process for storing the data to be written in the decided areas. In the areas decided as areas in which the data to be written is stored, the data to be written, which is copied by the server 23 to be made redundant, is respectively stored.

In the storage process, when a disk including a decided area is managed by a different server, the arrangement unit 55 transmits, to the server that manages the disk including the decided area, a write instruction including storage position information that indicates the area in which data to be written is stored and the data to be written.

Upon receipt of the write instruction including the information indicating the write position and the data to be written from the different server, the arrangement unit 55 stores the data to be written in the write position included in the received instruction.

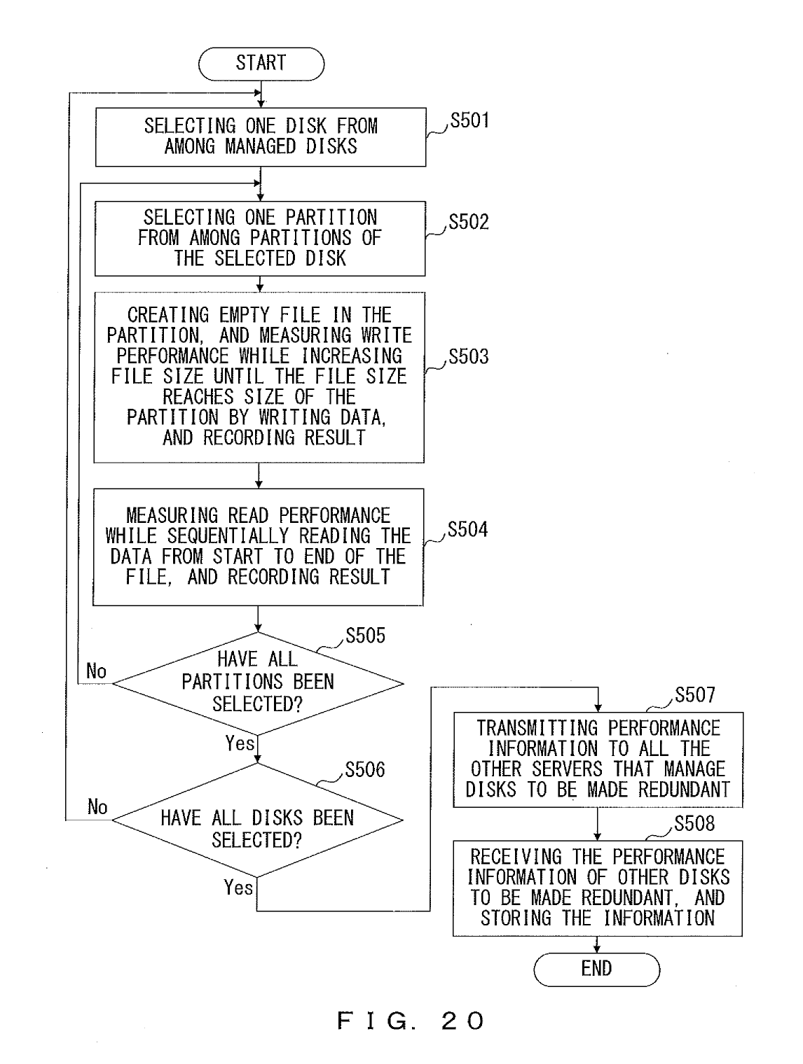

A flow of operations of measurements of a write performance and a read performance is described next. FIG. 20 is a flowchart illustrating details of the process for measuring the write performance and the read performance, according to the second embodiment.

In FIG. 20, the measurement unit 52 initially selects one disk from among disks managed by a server A4 (the server that executes the flow illustrated in FIG. 20) (S501).

Next, the measurement unit 52 selects one partition from among partitions of the disk selected in S501 (S502).

Then, the measurement unit 52 creates an empty file in the partition selected in S502, measures the write performance while increasing the file size until the file size reaches a size of the partition by writing the data, and records a result of the measurement in the performance information 61 (S503).

Next, the measurement unit 52 measures the read performance while sequentially reading the data from the start to the end of the file created in S503, and records a result of the measurement in the performance information 61 (S504).

Then, the measurement unit 52 determines whether all the partitions of the selected disk have been selected in S502 (S505). Namely, the measurement unit 52 determines whether the process from S503 to S504 has been executed for all the partitions of the disk selected in S501. When the measurement unit 52 determines that any of the partitions of the selected disk has not been selected yet in S502 (“NO” in S505), the process returns to S502, in which the measurement unit 52 selects one partition from among partitions that have not been selected yet (S502).

In S505, when the measurement unit 52 determines that all the partitions of the disk selected in S501 have been selected in S502 (“YES” in S505), the measurement unit 52 further determines whether all the disks managed by the server A4 have been selected in S501 (S506). Namely, the measurement unit 52 determines whether the process from S502 to S505 has been executed for all the disks managed by the server A4. When the measurement unit 52 determines that any of the disks managed by the server A4 has not been selected yet in S501 (“NO” in S506), the process returns to S501, in which the measurement unit 52 selects one disk from among disks that have not been selected yet (S501).

When the measurement unit 52 determines that all the disks managed by the server A4 have been selected in S501 (“YES” in S506), the performance information communication unit 53 executes the following process. Namely, the performance information communication unit 53 transmits the performance information 61 recorded in S503 and 5504 to all the other servers that manage disks to be made redundant (S507).

Next, the performance information communication unit 53 receives the performance information 61 of the other disks to be made redundant from the servers that manage the corresponding disks, and stores the performance information 61 in the performance management information 62 (S508). Note that the process of S508 is a process for receiving the performance information 61 transmitted in S507 in the initialization process of the other servers that make data redundant. Accordingly, this process may be executed at a specified timing of the flow illustrated in FIG. 20, and the order of execution is not particularly limited. Then, the process is terminated.

A flow of operations of the write process for the server that decides a storage position in the second embodiment is similar to that illustrated in FIG. 11. However, the operations of the empty area management unit 34 and the arrangement unit 35, which are illustrated in FIG. 11, are those of the empty area management unit 54 and the arrangement unit 55, respectively in the second embodiment. Moreover, the empty area information 43 and the empty area management information 44, which are illustrated in FIG. 11, are the empty area information 63 and the empty area management information 64, respectively in the second embodiment.

Additionally, a flow of operations of a process executed by the server that receives a storage position from the server that decides a storage position and executes the write process in the second embodiment is similar to that illustrated in FIG. 12. However, the operations of the empty area management unit 34 and the arrangement unit 35, which are illustrated in FIG. 12, are those of the empty area management unit 54 and the arrangement unit 55, respectively in the second embodiment. Moreover, the empty area information 43 illustrated in FIG. 12 is the empty area information 63 in the second embodiment.

Furthermore, a flow of operations of the process for deciding a storage position in the second embodiment is similar to that illustrated in FIG. 13. In FIG. 13, however, the “area” specifically indicates a “partition”. Moreover, the operations of the storage unit 31 and the arrangement unit 35, which are illustrated in FIG. 13, are those of the storage unit 51 and the arrangement unit 55, respectively in the second embodiment. Additionally, the performance management information 42 and the empty area management information 44, which are illustrated in FIG. 13, are the performance management information 62 and the empty area management information 64, respectively in the second embodiment.

A hardware configuration of the server 23 in the second embodiment is similar to that illustrated in FIG. 14. In FIG. 14, however, the CPU 601 provides some or all of the functions of the measurement unit 52, the performance information communication unit 53, the empty area management unit 54 and the arrangement unit 55 by executing a program that describes the abovementioned steps of the flowcharts with the use of the memory 602. Moreover, the memory 602 provides some or all of the functions of the storage unit 51.

In the first embodiment, slices are defined as areas in which addresses are physically successive in a disk. However, the slices may partially include a non-successive area. Examples of such a non-successive area include an alternate area allocated when an error occurs in a specified area within the slice.

Additionally, in storage areas in which data to be written is stored and which have a performance difference equal to or smaller than a specified threshold value, the same data is made redundant and stored. However, the data to be written is not limited to the same data. For example, data that are likely to be accessed at the same time may be respectively stored in the areas. By way of example, a plurality of pieces of data into which specified data are divided may be stored in areas having a performance difference equal to or smaller than a specified threshold value. Alternatively, for example, data to be written, and a parity of the data to be written may be stored respectively in areas having a performance difference equal to or smaller than a specified threshold value.

The embodiments refer to the examples where the storage system 20 includes the plurality of servers 23. However, the embodiments are applicable also to a case where a single server manages a plurality of disks.

According to an aspect of the embodiments, variations in a sequential access performance of a storage device can be suppressed.

Note that the embodiments are not limited to the above described ones, and various configurations or embodiments can be employed within a scope that does not depart from the gist of the embodiments.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A server apparatus comprising:
a storage unit configured to store speed information about a speed of a sequential access to a storage area for each specified storage area in each of a plurality of storage devices; and
a control unit configured to perform a process including:
selecting at least two storage devices among the plurality of storage devices in response to an access request made to any of the plurality of storage devices;
identifying storage areas having a difference in the speed of the sequential access that is equal to or slower than a specified threshold value from among the storage areas of the selected storage devices by using the speed information; and
storing data in each of the identified storage areas.

2. The server apparatus according to claim 1, wherein
the control unit selects at least two storage devices among the plurality of storage devices in accordance with the number of redundancies of the plurality of storage devices in response to the access request made to any of the plurality of storage devices, identifies the storage areas having a difference in the speed of the sequential access that is equal to or slower than the specified threshold value among the storage areas of the selected storage devices by using the speed information, and stores the data to be made redundant in each of the identified storage areas.

3. The server apparatus according to claim 1, wherein
the identified storage areas are storage areas of a combination having the highest speed among combinations of storage areas having the difference of the speed of the sequential access that is equal to or slower than the specified threshold value among the storage areas of the selected storage devices.

4. The server apparatus according to claim 1, wherein
the storage unit stores information about an empty area of each storage area of each of the plurality of storage devices, and
the control unit identifies storage areas, to which data can be written, on the basis of the information about the empty area, and stores the data in storage areas of the selected storage devices among the identified storage areas.

5. The server apparatus according to claim 1, wherein the process further including:
notifying the different server to write the data when the identified storage area is a storage area of a storage device managed by a different server apparatus.

6. A non-transitory computer-readable recording medium having stored therein a program for causing a computer to execute an information storing process comprising:
selecting at least two storage devices among a plurality of storage devices by using speed information, stored in a storage unit, about a speed of a sequential access to a storage area for each specified storage area in each of the plurality of storage devices in response to an access request made to any of the plurality of storage devices;
identifying storage areas having a difference in the speed of the sequential access that is equal to or slower than a specified threshold value among the storage areas of the selected storage devices by using the speed information; and
storing data in each of the identified storage areas.

7. The non-transitory computer-readable recording medium according to claim 6, wherein
the selecting selects at least two storage devices among the plurality of storage devices in accordance with the number of redundancies of the plurality of storage devices on an access request made to any of the plurality of storage devices,
the identifying identifies the specified threshold value among the storage areas of the selected storage devices by using the speed information, and
the storing stores the data to be made redundant to be stored respectively in identified storage areas.

8. The non-transitory computer-readable recording medium according to claim 6, wherein
the identified storage areas are storage areas of a combination having the highest speed among combinations of storage areas having a difference of the speed of the sequential access to the storage area that is equal to or slower than the specified threshold value among the storage areas of the selected storage devices.

9. The non-transitory computer-readable recording medium according to claim 6, wherein
the identifying identifies a storage area, to which data can be written, on the basis of information, stored in the storage unit, about an empty area of each storage area of each of the plurality of storage devices, and
the storing stores the data to be stored respectively in storage areas of the selected storage devices among the identified storage areas.

10. The non-transitory computer-readable recording medium according to claim 6, the information storing process further comprising
notifying a different server to write the data when the identified storage area is a storage area of a storage device managed by the different server.

11. An information storing method executed by a computer, the information storing method comprising:
selecting at least two storage devices among a plurality of storage devices by using speed information, stored in a storage unit, about a speed of a sequential access to a storage area for each specified storage area in each of the plurality of storage devices in response to an access request made to any of the plurality of storage devices;
identifying storage areas having a difference in the speed of the sequential access that is equal to or slower than a specified threshold value among the storage areas of the selected storage devices by using the speed information; and
storing data in each of the identified storage areas.

12. The information storing method according to claim 11, wherein
the selecting selects at least two storage devices among the plurality of storage devices in accordance with the number of redundancies of the plurality of storage devices on an access request made to any of the plurality of storage devices,
the identifying identifies the storage areas having a difference in the speed of the sequential access that is equal to or slower than a specified threshold value among the storage areas of the selected storage devices by using the speed information, and
the storing stores the data to be made redundant in each of the identified storage areas.

13. The information storing method according to claim 11, wherein
the identified storage areas are storage areas of a combination having the highest speed among combinations of storage areas having a difference of the speed of the sequential access to the storage area that is equal to or slower than the specified threshold value among the storage areas of the selected storage devices.

14. The information storing method according to claim 11, wherein
the identifying identifies a storage area, to which data can be written, on the basis of information, stored in the storage unit, about an empty area of each storage area of each of the plurality of storage devices, and
the storing stores the data respectively in storage areas of the selected storage devices among identified storage areas.

15. The information storing method according to claim 11, further comprising
notifying a different server to write the data when the identified storage area is a storage area of a storage device managed by the different server.
